(19) United States
(12) Patent Application Publication
(10) Pub. No.: US 2015/0252220 A1
(43) Pub. Date: Sep. 10, 2015

(54) Curable Silicone Composition, And Semiconductor Sealing Material And Optical Semiconductor Device Using The Same

(71) Applicant: DOW CORNING TORAY CO., LTD., Tokyo (JP)

(72) Inventors: Tadashi Okawa, Ichihara-shi (JP); Kazuhiko Kojima, Ichihara-shi (JP); Haruhiko Furukawa, Ichihara-shi (JP)

(21) Appl. No.: 14/428,773

(22) PCT Filed: Sep. 20, 2013
(86) PCT No.: PCT/JP2013/076886

§ 371 Date: Mar. 17, 2015

(30) Foreign Application Priority Data
Sep. 21, 2012 (JP) 2012-208699

(51) Int. Cl. C09D 183/04; C08K 9/06

(52) U.S. Cl. CPC C09D 183/04; C08K 9/06; C08K 2003/2237

(57) ABSTRACT

A curable silicone composition comprising: an organopolysiloxane represented by the average unit formula: (R¹₃—SiO_{1/2})ₐ(R¹₂SiO_{2/2})_{b}(R²SiO_{3/2})_{c}(SiO_{4/2})_{d} (wherein the R¹ moieties are alkyl groups, alkenyl groups, phenyl groups, or hydrogen atoms; the R² moieties are groups represented by R¹, condensed polycyclic aromatic groups, or groups including a condensed polycyclic aromatic group, provided that at least one of the R¹ and R² moieties in the molecule is an alkenyl group or hydrogen atom and at least one R² moiety in the molecule is a condensed polycyclic aromatic group or a group having a condensed polycyclic aromatic group; and a, b, c, and d are numbers satisfying the relationship: 0.01≦a≦0.8, 0≦b≦0.5, 0.2≦c≦0.9, 0≦d<0.2, and a+b+c+d=1); and metal oxide microparticles with an average particle size of at most 500 nm and a refractive index of at least 1.55.

### TECHNICAL FIELD

A Priority is claimed on Japanese Patent Application No. 2012-208699 filed on September 21, the content of which are incorporated herein by reference.

The present invention relates to a curable silicone which yields a cured product with excellent transparency and high refringency and a semiconductor sealing material and optical semiconductor device using the same.

### BACKGROUND ART

Curable silicone compositions are used as sealants for LEDs, raw materials for lenses, and the like due to their excellence in transparency and heat resistance. In order to increase the refractive index of a cured product, an aryl group such as a phenyl group or a naphthyl group is typically introduced into an organopolysiloxane serving as a structural component. For example, organopolysiloxanes having a condensed polycyclic aromatic group such as a naphthyl group, an anthracenyl group, or a phenanthryl group as a T unit—that is, as R in a siloxane represented by the general formula: RSiO_{3/2}—are proposed in Patent Documents 1 to 4. However, such organopolysiloxanes do not form cured products with a high refractive index, high transparency, or excellent heat resistance as a result of a hydrosilylation reaction.

In addition, an organopolysiloxane having a condensed polycyclic aromatic group such as a naphthyl group, an anthracenyl group, or a phenanthryl group as a D unit—that is, as R in a siloxane represented by the general formula: R²SiO_{2/2} is proposed in Patent Document 5. However, such an organopolysiloxane has the problem that the cured product typically becomes hard and brittle as the refractive index of the cured product is increased, and the mechanical characteristics and heat resistance of the cured product are diminished as a result.

In order to solve these problems, in Patent Document 6, the present applicants proposed a curable silicone composition in which at least 50 mol % of the R moieties in a siloxane represented by RSiO_{3/2} are condensed polycyclic aromatic groups such as naphthyl groups or groups containing condensed polycyclic aromatic groups and which form a cured product with a high refractive index, high transparency, and excellent heat resistance when cured by a hydrosilylation reaction as a result of regulating the content of the siloxane units. However, although the addition of various fluorescent materials and inorganic fillers such as silica is described in this document, there is no mention or suggestion of the surface treatment thereof. Further, there is no mention or suggestion of further improving the refractive index by using metal oxide microparticles with a high refractive index.

On the other hand, in optical material applications such as light-emitting diodes (LEDs), metal oxide microparticles have been used in recent years to secure or improve the function of the light-emitting diodes. However, since metal oxide microparticles have high surface hydrophilicity in the untreated state, the microparticles may aggregate and cause poor dispersion of other hydrophobic resins or the like into the matrix. In particular, metal oxide microparticles having a high refractive index and a particle size so small that light scattering can be ignored are useful for obtaining optical materials with a high refractive index, but it is difficult to finely and stably disperse these optical fine members into silicone resins with high hydrophobicity. Therefore, several treatment methods have been proposed in order to solve these problems (see Patent Documents 7 to 11).

However, known surface treatment agents for optical materials do not comprise a specific functional group bonded to silicon and a siloxane portion, and the surface treatment performance thereof is not satisfactory. Further, the siloxane portion of a known surface treatment agent primarily consists of a silane or a dimethyl silicone portion with a low refractive index, and there is no mention or suggestion of a surface treatment agent or the concept of a surface treatment agent which itself has a high refractive index. In addition, there is no mention or suggestion in the documents describing these known surface treatment agents regarding surface treatment agents which have a specific functional group, have a high overall refractive index, and have a functional group which is reactive with hydrophobic resins.

### PRIOR ART DOCUMENTS

### Patent Documents

Patent Document 1: Japanese Unexamined Patent Application Publication No. 2008-024832
Patent Document 2: Japanese Unexamined Patent Application Publication No. 2009-203463
Patent Document 3: Japanese Unexamined Patent Application Publication No. 2009-280666
Patent Document 4: Japanese Unexamined Patent Application Publication No. 2010-007057
Patent Document 5: Japanese Unexamined Patent Application Publication No. 2000-235103
Patent Document 6: Japanese Patent Application No. 2011-151312 (unpublished at the time of this application)
Patent Document 7: Japanese Unexamined Patent Application Publication No. 2011-026444
Patent Document 8: Japanese Unexamined Patent Application Publication No. 2010-241935
Patent Document 9: Japanese Unexamined Patent Application Publication No. 2010-195646
Patent Document 10: Japanese Unexamined Patent Application Publication No. 2010-144137
Patent Document 11: WO2010/026992

### SUMMARY OF INVENTION

### Technical Problem

An object of the present invention is to provide a curable silicone composition which contains metal oxide microparticles exhibiting a high refractive index and forms a cured product with a high refractive index, high transparency, excellent heat resistance, and low water vapor permeability when cured by a hydrosilylation reaction. Another object of the present invention is to provide a cured product with a high refractive index, high transparency, and excellent heat resistance. Yet another object of the present invention is to provide a highly reliable optical semiconductor device using this curable silicone composition.

### Solution to Problem

As a result of intensive investigation aimed at achieving the above objects, the present inventors arrived at the present invention. That is, the curable silicone composition of the present invention is cured by a hydrosilylation reaction and comprises: an organopolysiloxane represented by the average unit formula:

(R¹₃SiO_{1/2})ₐ(R¹₂SiO_{2/2})_{b}(R²SiO_{3/2})_{c}(SiO_{4/2})_{d}

(wherein the R¹ moieties are alkyl groups, alkenyl groups, phenyl groups, or hydrogen atoms; the R² moieties are groups represented by R¹, condensed polycyclic aromatic groups, or groups including a condensed polycyclic aromatic group, provided that at least one of the R¹ and R² moieties in the molecule is an alkenyl group or hydrogen atom and at least one R² moiety in the molecule is a condensed polycyclic aromatic group or a group including a condensed polycyclic aromatic group; and a, b, c, and d are numbers satisfying the formulae: 0.01≦a≦0.8, 0≦b≦0.5, 0.2≦c≦0.9, 0≦d<0.2, and a+b+c+d=1);
and
(B) metal oxide microparticles with a cumulant average particle size of at most 500 nm and a refractive index of at least 1.55 for light of a wavelength of 633 nm at 25° C.

The objects of the present invention are more preferably achieved by a curable silicone composition in which the metal oxide microparticles serving as component (B) are surface treated using (C) an organic silicon compound having a functional group selected from a highly polar functional group, a hydroxyl group-containing group, a silicon-bonded hydrolyzable group, or metal salt derivatives thereof bonded to silicon atoms directly or via a functional group and having at least one structure in the molecule in which the silicon atoms are bonded to other siloxane units. Further, the object of the present invention is preferably achieved by a cured product of the curable silicone composition and an optical semiconductor device formed by covering or sealing an optical semiconductor element with the cured product.

Specifically, the objects of the present invention are achieved by:

“[1] A curable silicone composition comprising:
(A) an organopolysiloxane represented by the average unit formula:

(R¹₃SiO_{1/2})ₐ(R¹₂SiO_{2/2})_{b}(R²SiO_{3/2})_{c}(SiO_{4/2})_{d}

(wherein, the R¹ moieties are alkyl groups, alkenyl groups, phenyl groups, or hydrogen atoms; the R² moieties are groups recited for the R¹ moieties, condensed polycyclic aromatic groups, or groups including a condensed polycyclic aromatic group, provided that at least one of the R¹ and R² moieties in the molecule is an alkenyl group or hydrogen atom and at least one R² moiety in the molecule is a condensed polycyclic aromatic group or a group including a condensed polycyclic aromatic group; and a, b, c, and d are numbers satisfying the formulae: 0.01≦a≦0.8, 0≦b≦0.5, 0.2≦c≦0.9, 0≦d<0.2, and a+b+c+d=1).
and
(B) metal oxide microparticles with a cumulant average particle size of at most 500 nm and a refractive index of at least 1.55 for light of a wavelength of 633 nm at 25° C.
[2] The curable silicone composition according to [1], wherein component (A) is an organopolysiloxane in which at least 50 mol % of the R² moieties in the formula are condensed polycyclic aromatic groups or groups containing condensed polycyclic aromatic groups.
[3] The curable silicone composition according to [1] or [2], wherein component (A) is an organopolysiloxane in which at least 50 mol % of the R² moieties in the formula are naphthyl groups.
[4] The curable silicone composition according to any one of [1] to [3], further comprising (C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1) (n is a number equal to 1 or greater) and
having at least one structure in the molecule in which the silicon atoms are bonded to any siloxane unit represented by R³¹₃SiO_{1/2}, R³¹₂SiO_{2/2}, R³¹SiO_{3/2}, and SiO_{4/2} (wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1)).
[5] The curable silicone composition according to [4], wherein component (B) comprises metal oxide microparticles surface-treated by component (C).
[6] The curable silicone composition according to any one of [1] to [5], wherein the refractive index after curing is at least 1.55.
[7] The curable silicone composition according to any one of [1] to [6] comprising: (A1) an organopolysiloxane represented by the average unit formula:

(R¹¹₃SiO_{1/2})ₐ(R¹¹₂SiO_{2/2})_{b}(R₂₁SiO_{3/2})_{c}(SiO_{4/2})_{d}

(wherein the R¹¹ moieties are alkyl groups, alkenyl groups, or phenyl groups; the R²¹ moieties are groups represented by R¹¹, condensed polycyclic aromatic groups, or groups including a condensed polycyclic aromatic group, provided that at least one of the R¹¹ and R²¹ moieties in the molecule is an alkenyl group and at least 50 mol % of the R²¹ moieties in the molecule are naphthyl groups; and a, b, c, and d are numbers satisfying the formulae: 0.01≦a≦0.8, 0≦b≦0.5, 0.2≦c≦0.9, 0≦d<0.2, and a+b+c+d=1);
(B) metal oxide microparticles with a cumulant average particle size of at most 200 nm and a refractive index of at least 1.55;
(C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1) (n is a number equal to 1 or greater) and
having at least one structure in the molecule in which the silicon atoms are bonded to any siloxane unit represented by R³¹₃SiO_{1/2}, R³¹₂SiO_{2/2}, R³¹SiO_{3/2}, and SiO_{4/2} (wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1));
(D1) an organopolysiloxane having at least two silicon-bonded hydrogen atoms in each molecule; and
(E) a hydrosilylation reaction catalyst.
[8] The curable silicone composition according to any one of [1] to [6] comprising: (A2) an organopolysiloxane represented by the average unit formula:

R¹²₃SiO_{1/2})ₐ(R¹²₂SiO_{2/2})_{b}(R²²SiO_{3/2})_{c}(SiO_{4/2})_{d}

(wherein the R¹² moieties are alkyl groups, phenyl groups, or hydrogen atoms; the R²² moieties are groups represented by R¹², condensed polycyclic aromatic groups, or groups including a condensed polycyclic aromatic group, provided that at least one of the R¹² and R²² moieties in the molecule is a hydrogen atom and at least 50 mol % of the R²² moieties in the molecule are naphthyl groups; and a, b, c, and d are numbers satisfying the formulae: 0.01≦a≦0.8, 0≦b≦0.5, 0.2≦c≦0.9, 0≦d<0.2, and a+b+c+d=1);
(B) metal oxide microparticles with a cumulant average particle size of at most 200 nm and a refractive index of at least 1.55;
(C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1) (n is a number equal to 1 or greater) and
having at least one structure in the molecule in which the silicon atoms are bonded to any siloxane unit represented by R³¹₃SiO_{1/2}, R³¹₂SiO_{2/2}, R³¹SiO_{3/2}, and SiO_{4/2} (wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1));
(D2) an organopolysiloxane having at least two alkenyl groups in each molecule; and
(E) a hydrosilylation reaction catalyst.
[9] The curable silicone composition according to any one of [4] to [8], wherein component (C) is an organic silicon compound having: an alkenyl group or a silicon-bonded hydrogen atom in the molecule; and
a silicon-bonded hydrolyzable group or hydroxyl group bonded to silicon atoms directly or via a functional group with a valency of (n+1) (n is a number equal to 1 or greater).
[10] The curable silicone composition according to any one of [1] to [9], further comprising (F) a fluorescent material.
[11] A cured product produced by curing the curable silicone composition described in any one of [1] to [10].
[12] A semiconductor sealing material comprising the curable silicone composition according to any one of [1] to [10].
[13] An optical semiconductor device formed by covering or sealing an optical semiconductor element with the curable silicone composition according to any one of [1] to [10].”

### Advantageous Effects of Invention

With the present invention, it is possible to provide a curable silicone which contains metal oxide microparticles exhibiting a high refractive index and form a cured product with a high refractive index, high transparency, excellent heat resistance, and low water vapor permeability when cured by a hydrosilylation reaction. In particular, it is possible to provide a curable silicone composition which forms a silicone cured product with a high refractive index of at least 1.55 after curing. In addition, with the present invention, it is possible to provide a cured product with a high refractive index, high transparency, excellent heat resistance, and low water vapor permeability. Further, with the present invention, it is possible to provide a highly reliable optical semiconductor device using this curable silicone composition.

### DESCRIPTION OF EMBODIMENTS

The curable silicone composition of the present invention comprises (A) an organopolysiloxane represented by the average unit formula:

(R¹₃SiO_{1/2})ₐ(R¹₂SiO_{2/2})_{b}(R²SiO_{3/2})_{c}(SiO_{4/2})_{d}

and (B) metal oxide microparticles with a cumulant average particle size of at most 200 nm and a refractive index of at least 1.55 at 25° C., and the curable silicone composition is cured by a hydrosilylation reaction.

<Component (A)>

First, component (A) is the main component of the curable silicone composition of the present invention and is a component which forms a silicone cured product with a high refractive index by a hydrosilylation reaction. This component is identical to the main component of the curable silicone composition proposed by the present applicants in Japanese Patent Application No. 2011-151312.

In the formula, the R¹ moieties are alkyl groups, alkenyl groups, phenyl groups, or hydrogen atoms. Examples of the alkyl group of R¹ include a methyl group, an ethyl group, a propyl group, and a butyl group. Of these, a methyl group is preferable. Examples of the alkenyl group of R¹ include a vinyl group, an allyl group, and a butenyl group. Of these, a vinyl group is preferable.

In the formula, R² is an alkyl group, an alkenyl group, a phenyl group, a hydrogen atom, or is a condensed polycyclic aromatic group or a group including a condensed polycyclic aromatic group. Examples of the alkyl group of R² include the groups represented by R¹. Examples of the alkenyl group of R² include the groups represented by R¹. Examples of the condensed polycyclic aromatic group of R² include a naphthyl group, an anthracenyl group, a phenanthryl group, a pyrenyl group, and such condensed polycyclic aromatic groups where a hydrogen atom is replaced by an alkyl group such as a methyl group, an ethyl group, and the like; by an alkoxy group such as a methoxy group, an ethoxy group, and the like; or by a halogen atom such as a chlorine atom, a bromine atom, and the like. The condensed polycyclic aromatic group of R² is preferably the naphthyl group. Examples of the group including a condensed polycyclic aromatic group of R² include alkyl groups including a condensed polycyclic aromatic group such as a naphthyl ethyl group, a naphthyl propyl group, an anthracenyl ethyl group, a phenanthryl ethyl group, a pyrenyl ethyl group, and the like; and such groups where a hydrogen atom in the condensed polycyclic aromatic group is replaced by an alkyl group such as a methyl group, an ethyl group, and the like; by an alkoxy group such as a methoxy group, an ethoxy group, and the like; or by a halogen atom such as a chlorine atom, a bromine atom, and the like.

Further, in the formula, at least one of the R¹ or R² moieties in one molecule is an alkenyl group or hydrogen atom. Moreover, in the formula, at least one R² moiety in one molecule is a condensed polycyclic aromatic group or a group including a condensed polycyclic aromatic group. Preferably, at least 50 mol % of the R² moieties in one molecule are condensed polycyclic aromatic groups or a group including a condensed polycyclic aromatic group.

Further, in the formula, a, b, c, and d are numbers that satisfy the formulae: 0.01≦a≦0.8, 0≦b≦0.5, 0.2≦c≦0.9, 0≦d<0.2, and a+b+c+d=1. Preferably, a, b, c, and d are numbers that satisfy the formulae: 0.05≦a≦0.7, 0≦b≦0.4, 0.3≦c≦0.9, 0≦d<0.2, and a+b+c+d=1. Particularly preferably, a, b, c, and d are numbers that satisfy the formulae: 0.1≦a≦0.6, 0≦b≦0.3, 0.4≦c≦0.9, 0≦d<0.2, and a+b+c+d=1. When the value of a is below the lower limit of the range described above, the obtained organopolysiloxane changes from the liquid state to solid state, and handling and processability declines. On the other hand, transparency of the obtained cured product declines if a exceeds the upper limit of the range described above. Further, stickiness of the obtained cured product occurs when b exceeds the upper limit of the range described above. Further, the refractive index of the obtained cured product may markedly decline if c is less than the lower limit of the range described above. On the other hand, the cured product becomes excessively rigid and brittle if c exceeds the upper limit of the range described above. Further, the cured product becomes extremely rigid and brittle if d exceeds the upper limit of the range described above.

The method of preparation of this type of organopolysiloxane is exemplified by a method, in the presence of an acid or base, of hydrolysis and condensation reaction of a silane compound (I) represented by the general formula:

R³SiX₃

a disiloxane (II) represented by the general formula:

R⁴₃SiOSiR⁴₃

and/or a silane compound (III) represented by the general formula:

R⁴₃SiX

The silane (I) represented by the general formula:

R³SiX₃

is a raw material for introducing a condensed polycyclic aromatic group or a group including a condensed polycyclic aromatic group to the obtained organopolysiloxane. In the formula, R³ is a condensed polycyclic aromatic group or a group including a condensed polycyclic aromatic group. Examples of the condensed polycyclic aromatic group of R³ include a naphthyl group, an anthracenyl group, a phenanthryl group, a pyrenyl group, and such condensed polycyclic aromatic groups where a hydrogen atom is replaced by an alkyl group such as a methyl group, an ethyl group, and the like; by an alkoxy group such as a methoxy group, an ethoxy group, and the like; or by a halogen atom such as a chlorine atom, a bromine atom, and the like. Of these, the naphthyl group is preferable. Examples of the group including a condensed polycyclic aromatic group of R³ include alkyl groups including a condensed polycyclic aromatic group such as a naphthyl ethyl group, a naphthyl propyl group, an anthracenyl ethyl group, a phenanthryl ethyl group, a pyrenyl ethyl group, and the like; and such groups where a hydrogen atom in the condensed polycyclic aromatic group is replaced by an alkyl group such as a methyl group, an ethyl group, and the like; by an alkoxy group such as a methoxy group, an ethoxy group, and the like; or by a halogen atom such as a chlorine atom, a bromine atom, and the like. Further, in the formula, X is an alkoxy group, an acyloxy group, a halogen atom, or a hydroxyl group. Examples of the alkoxy group of X include a methoxy group, an ethoxy group, and a propoxy group. Examples of the acyloxy group of X include an acetoxy group. Examples of the halogen atom of X include a chlorine atom, and a bromine atom.

This type of silane compound (I) is exemplified by alkoxysilanes such as naphthyltrimethoxysilane, anthracenyl trimethoxysilane, phenanthryl trimethoxysilane, pyrenyl trimethoxysilane, naphthyltriethoxysilane, anthracenyl triethoxysilane, phenanthryl triethoxysilane, pyrenyl triethoxysilane, and the like; acyloxysilanes such as naphthyl triacetoxysilane, anthracenyl triacetoxysilane, phenanthryl triacetoxysilane, pyrenyl triacetoxysilane, and the like; halosilanes such as naphthyl trichlorosilane, anthracenyl trichlorosilane, phenanthryl trichlorosilane, pyrenyl trichlorosilane, and the like; and hydroxy silanes such as naphthyl trihydroxy silane, anthracenyl trihydroxy silane, phenanthryl trihydroxy silane, pyrenyl trihydroxy silane, and the like.

In addition, the disiloxane (II) represented by the general formula:

R⁴₃SiOSiR⁴₃

is a raw material for introducing M units of siloxane into the obtained organopolysiloxane. In the formula, the R⁴ moieties are alkyl groups, alkenyl groups, or phenyl groups. Examples of the alkyl group of R⁴ include a methyl group, an ethyl group, and a propyl group. Of these, a methyl group is preferable. Examples of the alkenyl group of R⁴ include a vinyl group, an allyl group, and a butenyl group. Of these, a vinyl group is preferable.

This type of disiloxane (II) is exemplified by 1,3-divinyl-tetramethyldisiloxane, 1,3-divinyl-1,3-diphenyl-dimethyldisiloxane, 1-vinyl-pentamethyldisiloxane, 1-vinyl-1,3-diphenyl-trimethyldisiloxane, and 1,3-diphenyl-tetramethyldisiloxane, hexamethyldisiloxane; and this disiloxane (II) is preferably a disiloxane having an alkenyl group.

In addition, the disiloxane (II) represented by the general formula:

R⁴₃SiX

is a raw material used for introduction of M units of siloxane in the obtained organopolysiloxane. In the formula, R⁴ is synonymous with the groups described above. In the formula, X is synonymous with the groups described above.

This type of silane compound (III) is exemplified by alkoxysilanes such as dimethylvinylmethoxysilane, methylphenylvinylmethoxysilane, diphenylvinylmethoxysilane, dimethylvinylethoxysilane, methylphenylvinylethoxysilane, diphenylvinylethoxysilane, trimethylmethoxysilane, dimethylphenylmethoxysilane, and the like; acyloxysilanes such as dimethylvinylacetoxysilane, methylphenylvinylacetoxysilane, diphenylvinylacetoxysilane, trimethylacetoxysilane, dimethylphenylacetoxysilane, and the like; halosilanes such as dimethylvinyl chlorosilane, methylphenylvinyl chlorosilane, diphenylvinyl chlorosilane, trimethyl chlorosilane, methyiphenyl chlorosilane, and the like; and silanols such as dimethylvinylsilanol, methylphenylvinylsilanol, diphenylvinylsilanol, and the like; and this silane compound (III) is preferably a silane compound having an alkenyl group.

As may be required, a silane compound (IV) represented by the general formula:

R⁴₍₄₋ₙ₎SiXₙ

may be used as a reactant in the above described preparation method. In the formula, R⁴ is synonymous with the groups described above. In the formula, X is synonymous with the groups described above. In the formula, “n” are integers from 2 to 4.

This type of silane compound (IV) is exemplified by alkoxysilanes such as trimethylmethoxysilane, trimethylethoxysilane, methyldiphenylmethoxysilane, methyldiphenylethoxysilane, dimethyldimethoxysilane, methylphenyldimethoxysilane, diphenyldimethoxysilane, methyltrimethoxysilane, phenyltrimethoxysilane, tetramethoxysilane, tetraethoxysilane, and the like; acetoxysilanes such as trimethylacetoxysilane, methyldiphenylacetoxysilane, methyldiphenylacetoxysilane, dimethyldiacetoxysilane, methylphenyldiacetoxysilane, diphenyldiacetoxysilane, methyltriacetoxysilane, phenyltriacetoxysilane, tetraacetoxysilane, and the like; halosilanes such as trimethylchlorosilane, methyldiphenylchlorosilane, methyldiphenylchlorosilane, dimethyldichlorosilane, methylphenyldichlorosilane, diphenyldichlorosilane, methyltrichlorosilane, phenyltrichlorosilane, tetrachlorosilane, and the like; and hydroxysilanes such as trimethylsilanol, methyldiphenylsilanol, methyldiphenylsilanol, dimethyldihydroxysilane, methylphenyldihydroxysilane, diphenyldihydroxysilane, methyltrihydroxysilane, phenyltrihydroxysilane, and the like.

Further, in the preparation method, at least one of the component (II) to component (IV) used in the reaction of the preparation method must have an alkenyl group.

The preparation method is characterized as performing hydrolysis and condensation reaction of the silane compound (I), the disiloxane (II) and/or the silane compound (III), and as may be required, the silane compound (IV), in the presence of an acid or a base. The charged ratio of each of the components is the ratio such that the obtained organopolysiloxane has the average unit formula below:

(R⁴₃SiO_{1/2})ₐ(R⁴₂SiO_{2/2})_{b}(R⁵SiO_{3/2})_{c}(SiO_{4/2})_{d}

That is to say, in the formula, R⁴ is synonymous with the groups described above. R⁵ is a group represented by R³ or is a group represented by R⁴. However, at least one of the R⁴ and R⁵ moieties in one molecule is an alkenyl group. At least one R⁵ moiety in one molecule is a condensed polycyclic aromatic group or a group including a condensed polycyclic aromatic group. Further, in the formula, a, b, c, and d are numbers that satisfy the formulae: 0.01≦a≦0.8, 0≦b≦0.5, 0.2≦c≦0.9, 0≦d<0.2, and a+b+c+d=1.

Acids that may be used are exemplified by hydrochloric acid, acetic acid, formic acid, nitric acid, oxalic acid, sulfuric acid, phosphoric acid, polyphosphoric acid, polycarboxylic acid, trifluoromethane sulfonic acid, and ion exchange resins. Further, the utilized base is exemplified by inorganic bases such as potassium hydroxide, sodium hydroxide, and the like; and organic base compounds such as triethylamine, diethylamine, monoethanolamine, diethanolamine, triethanolamine, ammonia water, tetramethylammonium hydroxide, alkoxysilanes having an amino group, aminopropyltrimethoxysilane, and the like.

Furthermore, an organic solvent may be used in the preparation method. The utilized organic solvent is exemplified by ethers, ketones, acetates, aromatic or aliphatic hydrocarbons, γ-butyrolactone, or the like; and mixtures of two or more types of such solvents. Preferred organic solvents are exemplified by propylene glycol monomethyl ether, propylene glycol monomethyl ether acetate, propylene glycol monoethyl ether, propylene glycol monopropyl ether, propylene glycol monobutyl ether, propylene glycol mono-t-butyl ether, γ-butyrolactone, toluene, and xylene.

In order to accelerate the hydrolysis and condensation reaction of each of the components in the preparation method, water or a mixed solution of water and alcohol is preferably added. Methanol and ethanol are preferred examples of the alcohol. This reaction is promoted by heating, and If an organic solvent is used, the reaction is preferably performed at the reflux temperature of the organic solvent.

Moreover, another preparation method of the organopolysiloxane is characterized as, in the presence of an acid, performing hydrolysis and condensation reaction of a silane compound (I) represented by the general formula:

R³SiX₃

a disiloxane (V) represented by the general formula:

R⁶₃SiOSiR⁶₃

and/or a silane compound (VI) represented by the general formula:

R⁶₃SiX

The silane (I) represented by the general formula:

R³SiX₃

is a raw material for introducing a condensed polycyclic aromatic group or a group including a condensed polycyclic aromatic group to the obtained organopolysiloxane. In the formula, R³ is a condensed polycyclic aromatic group or a group including a condensed polycyclic aromatic group; and examples thereof are the same as the groups described above. Moreover, X is an alkoxy group, an acyloxy group, a halogen atom, or a hydroxyl group; and examples thereof are the same as the groups described above. Examples of such silane compound (I) are the same as the compounds described above.

In addition, the disiloxane (V) represented by the general formula:

R⁶₃SiOSiR⁶₃

is a raw material for introducing M units of siloxane in the obtained organopolysiloxane. In the formula, the R⁶ moieties are alkyl groups, phenyl groups or hydrogen atoms. Examples of the alkyl group of R⁶ include a methyl group, an ethyl group, and a propyl group.

This type of disiloxane (V) is exemplified by 1,1,3,3-tetramethyldisiloxane, 1,3-diphenyl-1,3-dimethyldisiloxane, 1,1,3,3,3-pentamethyldisiloxane, 1,3-diphenyl-1,3,3-trimethyldisiloxane, 1,3-diphenyl-tetramethyldisiloxane, and hexamethyldisiloxane; and this disiloxane (V) is preferably a disiloxane having a silicon-bonded hydrogen atom.

In addition, the silane compound (VI) represented by the general formula:

R⁶₃SiX

is also a raw material for introducing M units of siloxane in the obtained organopolysiloxane. In the formula, R⁶ is synonymous with the groups described above. In the formula, X is synonymous with the groups described above.

This type of silane compound (VI) is exemplified by alkoxysilanes such as dimethylmethoxysilane, methylphenylmethoxysilane, diphenylmethoxysilane, dimethylethoxysilane, methylphenylethoxysilane, diphenylethoxysilane, trimethylmethoxysilane, dimethylphenylmethoxysilane, and the like; acyloxysilanes such as dimethylacetoxysilane, methylphenylacetoxysilane, diphenylacetoxysilane, trimethylacetoxysilane, dimethylphenylacetoxysilane, and the like; halosilanes such as dimethylchlorosilane, methylphenylchlorosilane, diphenylchlorosilane, trimethylchlorosilane, methylphenylchlorosilane, and the like; and silanols such as dimethylsilanol, methylphenylsilanol, diphenylsilanol, and the like. The silane compound (VI) is preferably a silane compound having a silicon-bonded hydrogen atom.

As may be required, a silane compound (VII) represented by the general formula:

R⁶₍₄₋ₙ₎SiXₙ

may be reacted in the preparation method. In the formula, R⁶ is synonymous with the groups described above. In the formula, X is synonymous with the groups described above. In the formula, “n” are integers from 2 to 4.

This type of silane compound (VII) is exemplified by alkoxysilanes such as trimethylmethoxysilane, trimethylethoxysilane, methyldiphenylmethoxysilane, methyldiphenylethoxysilane, dimethyldimethoxysilane, methylphenyldimethoxysilane, diphenyldimethoxysilane, methyltrimethoxysilane, phenyltrimethoxysilane, tetramethoxysilane, tetraethoxysilane, and the like; acetoxysilanes such as trimethylacetoxysilane, methyldiphenylacetoxysilane, methyldiphenylacetoxysilane, dimethyldiacetoxysilane, methylphenyldiacetoxysilane, diphenyldiacetoxysilane, methyltriacetoxysilane, phenyltriacetoxysilane, tetraacetoxysilane, and the like; halosilanes such as trimethylchlorosilane, methyldiphenylchlorosilane, methyldiphenylchlorosilane, dimethyldichlorosilane, methylphenyldichldrosilane, diphenyldichlorosilane, methyltrichlorosilane, phenyltrichlorosilane, tetrachlorosilane, and the like; and hydroxysilanes such as trimethylsilanol, methyldiphenylsilanol, methyldiphenylsilanol, dimethyldihydroxysilane, methylphenyldihydroxysilane, diphenyldihydroxysilane, methyltrihydroxysilane, phenyltrihydroxysilane, and the like.

Furthermore, at least one component among the component (V) to component (VII) used in the reaction of the preparation method must have a silicon-bonded hydrogen atom.

The preparation method is characterized in that a hydrolysis and condensation reaction, in the presence of an acid, is performed using the silane compound (I), the disiloxane (V) and/or the silane compound (VI), and as may be required, the silane compound (VII). The charged ratio of each of the components is the ratio such that the obtained organopolysiloxane has the average unit formula below:

(R⁶₃SiO_{1/2})ₐ(R⁶₂SiO_{2/2})_{b}(R⁷SiO_{3/2})_{c}(SiO_{4/2})_{d}

That is, in the formula, R⁶ is a group synonymous with the groups described above, and R⁷ is a group represented by R³ or is a group represented by R⁶. However, at least one of the R⁶ or R⁷ moieties in one molecule is a hydrogen atom, and at least one R⁷ moiety in one molecule is a condensed polycyclic aromatic group or a group including a condensed polycyclic aromatic group. Further, in the formula, a, b, c, and d are numbers that satisfy the formulae: 0.01≦a≦0.8, 0≦b≦0.5, 0.2≦c≦0.9, 0≦d<0.2, and a+b+c+d=1.

Acids that may be used are exemplified by strong acids such as hydrochloric acid, nitric acid, sulfuric acid, phosphoric acid, polyphosphoric acid, trifluoromethane sulfonic acid, and the like; carboxylic acids such as acetic acid, formic acid, oxalic acid, polycarboxylic acid, and the like, and carboxylic acid anhydrides such as acetic acid anhydride and the like.

Furthermore, an organic solvent may be used in the preparation method. Examples of the utilized organic solvent are the same as the solvents described above.

In order to accelerate the hydrolysis and condensation reaction of each of the components in the preparation method, water or a mixed solution of water and alcohol is preferably added. Methanol and ethanol are preferred examples of the alcohol. This reaction is promoted by heating, and if an organic solvent is used, the reaction is preferably performed at the reflux temperature of the organic solvent.

[Component (B)]

The metal oxide microparticles serving as component (B) are a characteristic component of the present invention. Since the microparticles have a high refractive index and are so small that light scattering can be ignored, the microparticles can further improve the refractive index and transparency of the resulting silicone cured product. In particular, these metal oxide microparticles have an even higher refractive index than phenyl-modified silicone or naphthyl-modified silicone cured products, as described below, so a cured product with a refractive index of at least 1.5.5 after curing can be obtained relatively easily.

The cumulant average particle size of such metal oxide microparticles is at most 500 nm, particularly preferably from 1 to 200 nm, and even more preferably from 1 to 150 nm from the perspective of the transparency of a silicone cured product containing the particles. Further, with the objective of improving the optical, electromagnetic, and mechanical characteristics of optical materials, these metal oxide microparticles may be—and are preferably—nanocrystalline particles or semiconductor nanocrystalline particles with a crystal diameter of from 10 to 100 nm. On the other hand, when the average particle size of the metal oxide microparticles exceeds the upper limit described above, light scattering becomes impossible to ignore, and it may not be possible to achieve the objective of improving the refractive index or the transparency.

Here, the “cumulant average particle size” is the average particle size of the microparticles calculated from the signal strength when measured with a dynamic light scattering particle size distribution meter using a cumulant method as a correlation calculation method and can be calculated, for example, by a conventional method from the measurement of the particle size distribution according to the dynamic light scattering method. Unless specified otherwise, “particle size” or “average particle size” will hereafter refer to the “cumulant average particle size.” In the experimental examples of the inventions of this application, the cumulant average particle size is measured using a Zeta-potential and Particle Size Analyzer ELSZ-2 (manufactured by Otsuka Electronics Co., Ltd.).

The metal oxide of component (B) has a refractive index of at least 1.55, preferably at least 1.70, and particularly preferably 1.90 for light of a wavelength of 633 nm at 25° C.

Examples of such a metal oxide include barium titanate, zirconium oxide, aluminum oxide (alumina), titanium oxide, strontium titanate, barium zirconate titanate, cerium oxide, cobalt oxide, indium tin oxide, hafnium oxide, yttrium oxide, tin oxide, niobium oxide, and iron oxide. In particular, a metal oxide containing at least one type of metal element selected from titanium, zirconium, and barium is preferable from the perspective of optical properties yielding a refractive index of at least 2.0 and electrical properties.

In particular, zirconium oxide has a relatively high refractive index (refractive index: 1.9 to 2.4) and is therefore useful for optical material applications which require a high refractive index and high transparency. Similarly, barium titanate has a high dielectric constant and a high refractive index (refractive index: 2.4) and is useful for imparting performance to the silicone cured product optically and electromagnetically.

By containing components (A) and (B) described above, the curable silicone composition of the present invention can form a silicone cured product with a high refractive index of at least 1.55 after curing. Further, it is possible to provide a cured product with excellent heat resistance and low water vapor permeability by using component (A). In addition, in accordance with the selection of component (B) and other fillers, the curable silicone composition of the present invention can provide a heat conductive or an electrically conductive cured product.

Further, the curable silicone composition of the present invention preferably contains a surface treatment agent—in particular, a surface treatment agent comprising an organic silicon compound. Surface-treating metal oxide microparticles such as barium titanate makes it possible to finely and stably disperse the metal oxide microparticles in a hydrophobic silicone resin and enables more stable large-scale compounding in comparison to untreated microparticles. As a result, there is the advantage that the optical properties (in particular, high refringence) and electromagnetic properties of the resulting cured product can be dramatically improved.

<Component (C)>

In particular, the curable silicone composition of the present invention preferably contains an organic silicon compound having a specific functional group bonded to silicon atoms in the molecule and having at least one structure in the molecule in which other siloxane units are bonded to the silicon atoms. This organic silicon compound has a site which interacts with the surface of the optical material directly or after hydrolysis and a site which provides characteristics originating from a silicon-based polymer in the same molecule and can therefore dramatically improve the dispersibility of the metal oxide microparticles in the curable silicone composition. Further, the organic silicon compound of the present invention preferably has a refractive index of at least 1.45, which is higher than that of an organic silicon compound primarily consisting of methyl siloxane units, which yields the advantage that the refractive index of the resulting silicone cured product will not be diminished and the transparency will not be lost. In addition, the organic silicon compound of the present invention preferably further contains a functional group which is hydrosilylation-reactive with the silicone composition, which yields the advantage that the surface-treated metal oxide microparticles or the like are stably dispersed in the curable resin and can be compounded in large quantities. Further, since a structure consisting of siloxane bonds (Si—O—Si), silalkylene bonds, or the like has excellent thermal stability, problems such as the yellowing or discoloration of metal oxide microparticles treated using the organic silicon compound or an optical device containing the metal oxide microparticles are unlikely to arise, which yields the advantage that the heat resistance is improved.

More specifically, the organic silicon compound of the present invention is an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1) (n is a number equal to 1 or greater) and

having at least one structure in the molecule in which the silicon atoms are bonded to any siloxane unit represented by R³¹₃SiO_{1/2}, R³¹₂SiO_{2/2}, R³¹SiO_{3/2}, and SiO_{4/2} (wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1)). In addition, this organic silicon compound preferably has a refractive index of at least 1.45 at 25° C. and further contains a hydrosilylation-reactive functional group in the molecule.

A first feature of the organic silicon compound of the present invention is that the organic silicon compound has a functional group selected from a highly polar functional group, a hydroxyl group-containing group, a silicon atom-containing hydrolyzable group, or metal salt derivatives thereof bonded to silicon atoms directly or via a functional group with a valency of (n+1) (n is a number equal to 1 or greater). By interacting with the surface of the metal oxide microparticles, this functional group can align, modify, or form bonds with the organic silicon compound of the present invention on the surface of the metal oxide microparticles and thereby modify the characteristics of the surface. This interaction with the surface is an interaction or bond reaction with the material surface caused by the polarity of the functional group, the formation of hydrogen bonds caused by terminal hydroxyl groups, or a bond reaction with the material surface caused by a hydrolyzable functional group, and these interactions may be applied during or after the formation of the target metal oxide microparticles. In particular, at the time of the treatment of metal oxide microparticles with high surface hydrophilicity in the untreated state, the interaction between the material surface and these functional groups is strong, which has the advantage that an excellent surface-modifying effect can be realized even when a small amount is used.

These functional groups bond to silicon atoms directly or via functional groups with a valency of (n+1) (n is a number equal to 1 or greater), but with the exception of cases in which the functional groups are hydroxyl groups (silanol groups), the functional groups preferably bond to silicon atoms via functional groups with a valency of (n+1) from the perspective of the surface-modifying effect. A functional group with a valency of (n+1) may be a linkage group with a valency of 2 or higher and is preferably a hydrocarbon group with a valency of 2 or higher which may contain hetero atoms (N, Si, O, P, S, or the like). A functional group with a valency of (n+1) may also be a linkage group with a valency of 3 or higher, and a structure in which two or more types of the same or different functional groups selected from highly polar functional groups, hydroxyl group-containing groups, silicon atom-containing hydrolyzable groups, or metal salt derivatives thereof are bonded to the linkage groups (for example, a highly polar functional group having a structure in which two carboxyl groups are bonded via trivalent functional groups) is included in the scope of the present invention.

More specifically, the functional group with a valency of (n+1) is a straight-chain or branched alkylene group which may contain hetero atoms selected from nitrogen, oxygen, phosphorus, and sulfur, an arylene group with a valency of 2 or higher, an alkenylene group with a valency of 2 or higher, an alkynylene group with a valency of 2 or higher, (poly)siloxane units, silalkylene units, or the like and is preferably a hydrocarbon group with a valency of 2 or higher to which a functional group (Q) is bonded in the alkylene portion or a portion other than the alkylene portion, the functional group (Q) being selected from a silicon atom or a highly polar functional group, a hydroxyl group-containing group, a silicon atom-containing hydrolyzable group, or metal salt derivatives thereof. The functional group with a valency of (n+1) is preferably a functional group with a valency of from 2 to 4 and is particularly preferably a divalent functional group.

The functional group (Q) bonded to silicon atoms directly or via this functional group with a valency of (n+1) (n is a number equal to 1 or greater) includes a functional group (Q) bonded to the alkylene portion, for example, and is represented by the following structural formulas. The structure may be a halogenated alkylene structure in which some of the hydrogen atoms of the alkylene portion in the formulas are substituted with halogen atoms such as fluorine, and the structure of the alkylene portion may be a straight-chain or a branched-chain structure.

-Q

—CᵣH₂ᵣ₋ₜ₁—Cₛ₁H₍₂ₛ₁₊₁₋ₙ₎Qₙ

—CᵣH₂ᵣ-{T-Cₛ₂H₍₂ₛ₂₋ₙ₁₎Qₙ₁}ₜ₂₁-T-Cₛ₃H₍₂ₛ₃₊₁₋ₙ₂₎Qₙ₂

—CᵣH₂ᵣ-{T-Cₛ₂H₍₂ₛ₂₋ₙ₃₎Qₙ₃}ₜ₃-T-Cₛ₃H₂ₛ₃₊₁

—CᵣH₂ᵣ-{T-Cₛ₂H₍₂ₛ₂₋ₙ₄₎Qₙ₄}ₜ₄-T-Q

[wherein Q is the same group as described above;
r is a number within the range of from 1 to 20;
s1 is a number within the range of from 1 to 20;
s2 is a number within the range of from 0 to 20;
s3 is a number within the range of from 1 to 20;
n is the same number as described above;
t1, t2, or t4 is a number equal to 0 or greater; and
t3 is a number equal to 1 or greater.

However, (n1×t2+n2), (n3×t3), and (n4×t4+1) are respectively numbers that satisfy n; and the T moieties are independently single bonds, alkenylene groups having from 2 to 20 carbon atoms, arylene groups having from 6 to 22 carbon atoms, or divalent linkage groups represented by —CO—, —O—C(═O)—, —C(═P)—O—, —C(═O)—NH—, —O—, —S—, —O—P—, —NH—, —SiR⁹₂—, and —[SiR⁹₂O]ₜ₅— (wherein the R9 moieties are independently alkyl groups or aryl groups, and t5 is a number within the range of from 1 to 100).]

The functional group with a valency of (n+1) is particularly preferably a divalent linkage group, examples of which include a divalent hydrocarbon group (—Z¹—) or a group represented by -A-(R^{D2}₂SiO)ₑ₁R^{D2}₂Si—Z¹—.

Here, A and Z¹ are independently divalent hydrocarbon groups and are preferably alkylene groups having from 2 to 20 carbon atoms.

R^{D2} is an alkyl group or an aryl group and is preferably a methyl group or a phenyl group.

e1 is a number within the range of from 1 to 50, preferably within the range of from 1 to 10, and particularly preferably 1.

Q described above is a functional group selected from a highly polar functional group, a hydroxyl group-containing group, a silicon-bonded hydrolyzable group, or metal salt derivatives thereof.

Specifically, highly polar functional groups are polar functional groups containing hetero atoms (O, S, N, P, or the like) which interact with the substrate surface or reactive functional groups (including hydrophilic groups) present on the substrate surface to bond or align the organic silicon compound with the substrate surface, thereby contributing to the modification of the surface. Examples of such highly polar functional groups include functional groups having polyoxyalkylene groups, cyano groups, amino groups, imino groups, quaternary ammonium groups, carboxyl groups, ester groups, acyl groups, carbonyl groups, thiol groups, thioether groups, sulfone groups, hydrogen sulfate groups, sulfonyl groups, aldehyde groups, epoxy groups, amide groups, urea groups, isocyanate groups, phosphoric acid groups, oxyphosphoric acid groups, and carboxylic anhydride groups, or the like. These highly polar functional groups are preferably functional groups derived from amines, carboxylic acids, esters, amides, amino acids, peptides, organic phosphorus compounds, sulfonic acids, thiocarboxylic acids, aldehydes, epoxy compounds, isocyanate compounds, or carboxylic acid anhydrides.

A hydroxyl group-containing group is a hydrophilic functional group having a silanol group, an alcoholic hydroxyl group, a phenolic hydroxyl group, or a polyether hydroxyl group which typically induces dehydrative condensation or forms one or more hydrogen bonds with the substrate surface, which is an inorganic substance (M) so as to bond or align the organic silicon compound with the substrate surface, thereby contributing to the modification of the surface. Specific examples include silanol groups bonded to silicon atoms, monovalent or polyvalent alcoholic hydroxyl groups, sugar alcoholic hydroxyl groups, phenolic hydroxyl groups, and polyoxyalkylene groups having OH groups at the terminals. These are preferably functional groups derived from hydroxysilanes, monovalent or polyvalent alcohols, phenols, polyether compounds, (poly)glycerin compounds, (poly)glycidyl ether compounds, or hydrophilic sugars.

A silicon atom-containing hydrolyzable group is a functional group having at least one hydrolyzable group bonded to silicon atoms and is not particularly limited as long as the group is a silyl group having at least monovalent hydrolyzable atoms directly coupled with silicon atoms (atoms producing silanol groups by reacting with water) or monovalent hydrolyzable groups directly coupled with silicon atoms (groups producing silanol groups by reacting with water). Such a silicon atom-containing hydrolyzable group hydrolyzes to produce a silanol group, and this silanol group typically induces dehydrative condensation with the substrate surface, which is an inorganic substance (M) to form a chemical bond consisting of Si—O-M (substrate surface). One or two or more of these silicon atom-containing hydrolyzable groups may be present in the organic silicon compound of the present invention, and when two or more groups are present, the groups may be of the same or different types.

A preferable example of a silicon atom-containing hydrolyzable group is a silicon atom-containing hydrolyzable group represented by —SiR³⁵_{f}X_{3-f}. In the formula, R³⁵ is an alkyl group or an aryl group, X is a hydrolyzable group selected from alkoxy groups, aryloxy groups, alkenoxy groups, acyloxy groups, oxime groups, amino groups, amide groups, mercapto groups, aminoxy groups, and halogen atoms, and f is a number from 0 to 2. More specifically, X is a hydrolyzable group selected from alkoxy groups such as methoxy groups, ethoxy groups, and isopropoxy groups; alkenoxy groups such as isopropenoxy groups; acyloxy groups such as acetoxy groups and benzoyloxy groups; oxime groups such as methyl ethyl ketoxime groups; amino groups such as dimethylamino groups and diethylamino groups; amide groups such as N-ethylacetamide groups; mercapto groups; aminoxy groups, and halogen atoms, and alkoxy groups having from 1 to 4 carbon atoms, (iso)propenoxy groups, or chlorine are preferable. In addition, R³⁵ is preferably a methyl group or a phenyl group. Specific examples of these silicon atom-containing hydrolyzable groups include but are not limited to trichlorosilyl groups, trimethoxysilyl groups, triethoxysilyl groups, methyldimethoxysilyl groups, and dimethylmethoxysilyl groups.

Metal salt derivatives of the highly polar functional groups, hydroxyl group-containing groups, and silicon atom-containing hydrolyzable groups described above are functional groups in which some alcoholic hydroxyl groups, organic acid groups such as carboxyl groups, or —OH groups such as silonol groups, phosphoric acid groups, or sulfonic acid groups form a salt structure with a metal. Particularly preferable examples include alkali metal salts such as sodium, alkali earth metal salts such as magnesium, and aluminum salts. In these metal salt derivatives, the —O⁻ portion in the functional group electrostatically interacts with the substrate surface or forms hydrogen bonds so as to bond or align the organic silicon compound with the substrate surface, thereby contributing to the modification of the surface.

The functional group (Q) is particularly preferably a group selected from carboxyl groups, aldehyde groups, phosphoric acid groups, thiol groups, sulfo groups, alcoholic hydroxyl groups, phenolic hydroxyl groups, amino groups, ester groups, amide groups, polyoxyalkylene groups, and silicon atom-containing hydrolyzable groups represented by —SiR³⁵_{f}X_{3-f} (wherein R³⁵ is an alkyl group or an aryl group, X is a hydrolyzable group selected from an alkoxy group, an aryloxy group, an alkenoxy group, an acyloxy group, a ketoxymate group, and a halogen atom, and f is a number from 0 to 2) or metal salt derivatives thereof. In particular, when the organic silicon compound of the present invention is used to post-treat the surface of one or more optical fine members selected from fluorescent microparticles, metal oxide microparticles, metal microparticles, nanocrystalline structures, and quantum dots with the objective of improving the dispersibility thereof, carboxyl groups, monovalent or polyvalent alcoholic hydroxyl groups, polyoxyalkylene groups, and silicon atom-containing hydrolyzable groups represented by —SiR⁵_{f}X_{3-f} are preferably used.

A second feature of the organic silicon compound of the present invention is that silicon atoms having functional groups (Q) bonded directly or via functional groups with a valency of (n+1) (n is a number equal to 1 or greater) are bonded to a siloxane unit represented by one of R³¹₃SiO_{1/2}, R³¹₂SiO_{2/2}, R³¹SiO_{3/2}, and SiO_{4/2}. In this siloxane portion, other siloxane units bonding to the silicon atoms may further bond to other silicon atoms or other functional groups via divalent functional groups such as siloxane bonds (Si—O—Si) or silalkylene bonds, which makes it possible to impart the organic silicon compound of the present invention with characteristics originating from a hydrophobic silicon polymer or the like. More specifically, the organic silicon compound of the present invention interacts with the surface of the metal oxide microparticles via a functional group (Q) selected from the aforementioned highly polar functional groups, hydroxyl group-containing groups, silicon atom-containing hydrolyzable groups, or metal salt derivatives thereof, and the properties of the surface such as the hydrophobicity, fine dispersibility, and dispersion stability are modified by the characteristics originating from the silicon polymer. In addition, the affinity of the entire curable silicone composition is dramatically improved by this portion, which enables the compounding of large amounts of inorganic microparticle components such as metal oxide microparticles in accordance with the application of the optical material.

In the formula, R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1)). Here, the substituted or unsubstituted monovalent hydrocarbon groups are preferably independently an alkyl group having from 1 to 10 carbon atoms, an alkenyl group having from 2 to 10 carbon atoms, or an aryl group or an aralkyl group having from 6 to 22 carbon atoms, and examples include straight-chain, branched, or cyclic alkyl groups such as methyl, ethyl, n-propyl, i-propyl, n-butyl, i-butyl, s-butyl, pentyl, neopentyl, cyclopentyl, and hexyl; alkenyl groups such as vinyl groups, propenyl groups, butyl groups, pentyl groups, and hexenyl groups; phenyl groups, and naphthyl groups. R³¹ is industrially preferably a hydrogen atom, a methyl group, a vinyl group, a hexenyl group, a phenyl group, or a naphthyl group. In addition, the hydrogen atoms bonded to the carbon atoms of these groups of R³¹ may be at least partially substituted with halogen atoms such as fluorine. Further, the functional groups selected from highly polar functional groups, hydroxyl group-containing groups, silicon atom-containing hydrolyzable groups, and metal salt derivatives thereof bonded to the silicon atoms via functional groups with a valency of (n+1) are the same groups as those described above.

The organic silicon compound of the present invention preferably has a refractive index of at least 1.45 at 25° C. for the entire molecule. Since an organic silicon compound primarily consisting of methyl siloxane units has a refractive index of less than 1.45, such a compound may reduce the refractive index of the substrate or have an adverse effect on the transparency of compounded curable resins or the like as a result of surface treatment, but the organic silicon compound of the present invention has the advantage that the compound can provide a silicone cured product with a higher refractive index and better transparency than a conventionally known surface treatment agent. The organic silicon compound of the present invention preferably has a refractive index (value measured at 25° C. and 590 nm) of at least 1.49 and more preferably at least 1.50, but an organic silicon compound having a refractive index within the range of from 1.50 to 1.60 is particularly preferable. Further, an organic silicon compound with a high refractive index of at least 1.60 can be designed by increasing the ratio of the groups selected from phenyl groups, condensed polycyclic aromatic groups, and groups containing condensed polycyclic aromatic groups that constitute all of the silicon atom-bonded functional groups.

The method for designing the refractive index of the organic silicon compound of the present invention so as to fall within the range described above may use a metal-containing organic silicon compound having bonds between metal atoms and silicon atoms in the molecule to provide a high refractive index, but it is industrially preferable to introduce aromatic ring-containing organic groups which provide a high refractive index as silicon-bonded functional groups. In particular, it is preferable for at least 30 mol % of all of the silicon-bonded functional groups in the organic silicon compound of the present invention to be groups selected from phenyl groups, condensed polycyclic aromatic groups, and groups containing condensed polycyclic aromatic groups, and this makes it possible to easily design an organic silicon compound with a refractive index of at least 1.45. Excluding the silicon atoms in the functional groups (Q), it is more preferable for at least 40 mol % of the monovalent functional groups bonded to all of the silicon atoms in the molecule to be groups selected from phenyl groups, condensed polycyclic aromatic groups, and groups containing condensed polycyclic aromatic groups, and it is particularly preferable for from 40 to 80 mol % to be phenyl groups or naphthyl groups. The refractive index of the organic silicon compound increases as the ratio of these functional groups that are introduced increases, and an organic silicon compound into which the same number of naphthyl groups has been introduced tends to exhibit a higher refractive index than an organic silicon compound into which the same number of phenyl groups has been introduced.

The organic silicon compound of the present invention has at least two silicon atoms in the molecule as a result of having the structure described above, but from the perspective of the modification of the surface of the substrate, it is preferable for the organic silicon compound of the present invention to have from 2 to 1000 silicon atoms in the molecule. However, when the functional groups (Q) are silicon atom-containing hydrolyzable groups, it is preferable to have from 2 to 1000 silicon atoms in the molecule, excluding the silicon atoms in the functional groups (Q). Here, the number of silicon atoms in the organic silicon compound excluding the silicon atoms in the functional groups (Q) is more preferably from 2 to 500 atoms. The range of from 2 to 200 atoms is more preferable, and the range of from 2 to 100 atoms is particularly preferable.

In particular, component (C) is preferably used for the surface treatment of the metal oxide microparticles serving as component (B) and is preferably used for post treatment with the objective of improving the dispersibility thereof, so the number of silicon atoms in the organic silicon compound of the present invention is more preferably from 3 to 500 atoms and even more preferably within the range of from 5 to 200 atoms, and the range of from 7 to 100 atoms is particularly preferable. Further, component (C) of the present invention may use an organic silicon compound with a relatively large number of silicon atoms and an organic silicon compound with a relatively small number of silicon atoms in accordance with the type, size, and treatment method of component (B) used for treatment.

From the perspective of modifying the surface, it is preferable for at least 50 mol % of all of the monovalent functional groups bonded to silicon atoms to be monovalent hydrocarbon groups, and it is particularly preferable for at least 75 mol % of all of the monovalent functional groups bonded to silicon atoms to be monovalent hydrocarbon groups. Further, it is preferable for the number of silicon atoms having the functional groups (Q) bonded directly or via functional groups with a valency of (n+1) (n is a number equal to 1 or greater) in the organic silicon compound of the present invention (excluding the silicon atoms in the functional groups (Q)) to be a number no greater than ⅓ the number of all of the silicon atoms in the molecule (excluding the silicon atoms in the functional groups (Q)). From the perspective of modifying the surface of the optical material, the number is preferably at most ⅕, more preferably at most 1/10, and particularly preferably at most 1/20 the number of all of the silicon atoms in the molecule. At this time, it is preferable for at least 90 mol % of all of the monovalent functional groups bonded to silicon atoms to be monovalent hydrocarbon groups, and it is preferable for at least 30 mol % to be groups selected from phenyl groups, condensed polycyclic aromatic groups, and groups containing condensed polycyclic aromatic groups. The other monovalent hydrocarbon groups are preferably selected from methyl groups, vinyl groups, and hexenyl groups. From the perspective of the refractive index, it is particularly preferable for from 40 to 80 mol % of all of the monovalent functional groups to be phenyl groups or naphthyl groups.

The organic silicon compound aligns, modifies, or bonds to the surface of the surface-treated metal oxide microparticles, but by having reactive sites in the composition cured by a hydrosilylation reaction at this time, the compound is efficiently incorporated into the curing system for each treatment substrate, which yields the advantage that the dispersion stability and compounding stability are improved. Therefore, the organic silicon compound of the present invention preferably has a hydroxilylation-reactive functional group in the molecule. The number, type, and binding sites of this functional group is not limited, but there is preferably at least one functional group in the molecule, and examples of hydrosilylation-reactive functional groups include silicon-bonded hydrogen atoms, alkenyl groups, and acyloxy groups. In particular, in the present invention, there are preferably from 1 to 10 hydrosilylation-reactive functional groups in the molecule, and the compound preferably contains silicon-bonded hydrogen atoms or alkenyl groups having from 2 to 10 carbon atoms, or acyloxy groups having from 3 to 12 carbon atoms at the terminals or side chains of the polysiloxane portion.

Such an organic silicon compound may employ a straight-chain, branched-chain, reticulated (network), or ring-shaped molecular structure and is represented by the following average structural formula, including cases in which the compound contains bonds mediated by divalent functional groups between Si moieties of siloxane bonds or silalkylene bonds in the molecule.

(R^{M}₃SiO_{1/2})ₐ(R^{D}₂SiO_{2/2})_{b}(R^{T}SiO_{3/2})_{c}(SiO_{4/2})_{d}

In the formula, R^{M}, R^{D}, and R^{T} are independently monovalent hydrocarbon groups, hydrogen atoms, hydroxyl groups, alkoxy groups, groups having functional groups (Q) selected from highly polar functional groups, hydroxyl group-containing groups, silicon atom-containing hydrolyzable groups, or metal salt derivatives thereof bonded to silicon atoms directly or via functional groups with a valency of (n+1) represented by —Z-(Q)n described above, or divalent functional groups bonded to the Si atoms of other siloxane units. Here, the monovalent hydrocarbon groups are the same groups as described above, and examples of the divalent functional groups bonded to the Si atoms of other siloxane units include but are not limited to alkylene groups having from 2 to 20 carbon atoms and aralkylene groups having from 8 to 22 carbon atoms. From an industrial perspective and the perspective of modifying the surface of the optical material, it is preferable for at least 50 mol % of all of the R^{M}, R^{D}, and R^{T} moieties to be monovalent hydrocarbon groups, and it is particularly preferable for at least 75 mol % to be monovalent hydrocarbon groups. In addition, in order to improve the refractive index, it is preferable for at least 30 mol % of all of the R^{M}, R^{D}, and R^{T} moieties to be selected from phenyl groups, condensed polycyclic aromatic groups, and groups containing condensed polycyclic aromatic groups. In addition, it is even more preferable for at least one of all of the R^{M}, R^{D}, and R^{T} moieties to be a hydrosilylation-reactive functional group.

At least one of all of the R^{M}, R^{D}, and R^{T} moieties is a group having a functional group (Q) selected from highly polar functional groups, hydroxyl group-containing groups, silicon atom-containing hydrolyzable groups, or metal salt derivatives thereof bonded to silicon atoms directly or via functional groups with a valency of (n+1), wherein n is a number equal to 1 or greater, a to d are respectively 0 or positive numbers, and a+b+c+d is a number within the range of from 2 to 1000. Here, a+b+c+d is preferably from 2 to 500 and more preferably from 2 to 100. In addition, when used to post-treat the surface of an optical fine member with the objective of improving the dispersibility thereof, a+b+c+d is more preferably from 3 to 500, even more preferably within the range of from 5 to 200, and particularly preferably within the range of from 7 to 100. At this time, the number of silicon atoms having the functional groups (Q) in the average structural formula described above (x, excluding the silicon atoms in the functional groups (Q)) is preferably a number equal to at most ⅓ of a+b+c+d. From the perspective of modifying the surface of the optical material, the number is more preferably at most ⅕, even more preferably at most 1/10, and particularly preferably at most 1/20 of a+b+c+d.

The organic silicon compound of the present invention particularly preferably has an essentially hydrophobic a main chain siloxane structure consisting of straight-chain or branched-chain siloxane bonds or silalkylene bonds and has functional groups (Q) selected from highly polar functional groups, hydroxyl group-containing groups, silicon atom-containing hydrolyzable groups, or metal salt derivatives thereof bonded to silicon atoms of the side chains (including structures that are branched via silalkylene bonds or the like) or terminals directly or via functional groups with a valency of (n+1). At this time, with the objective of imparting advanced hydrophobicity or the like, a molecular design may be—and is preferably—employed so that the compound has a severely branched siloxane dendron structure or a siloxane macromonomer structure having a constant chain length. These hydrophobic siloxane structures and main chain siloxane structures are preferably bonded by divalent hydrocarbon groups such as silalkylenes.

Such an organic silicon compound is represented by the following average structural formula.

(R^{M1}₃SiO_{1/2})ₐ₁(R^{D1}SiO_{2/2})_{b1}(R^{T}SiO_{3/2})_{c1}(SiO_{4/2})_{d1}

In the formula, R^{M1}, R^{D1}, and R^{T1} are independently groups selected from:

monovalent hydrocarbon groups, hydrogen atoms, hydroxyl groups, alkoxy groups, groups having functional group (Q) selected from highly polar functional groups, hydroxyl group-containing groups, silicon atom-containing hydrolyzable groups, or metal salt derivatives thereof bonded to silicon atoms via divalent functional groups (Z¹) represented by —Z¹-Q; groups represented by -A-(R^{D2}₂SiO)ₑ₁R^{D2}₂Si—Z¹-Q (wherein A is a divalent hydrocarbon group, R^{D2} is an alkyl group or a phenyl group, e1 is a number within the range of from 1 to 50, and Z¹ and Q are the same groups as described above);

group represented by -A-(R^{D2}₂SiO)ₑ₁SiR^{M2}₃ (wherein A and R^{D2} are the same groups as described above, R^{M2} is an alkyl group or a phenyl group, and e1 is the same number as described above); or
groups represented by —O—Si(R^{D3})₂—X¹ (wherein R^{D3} is an alkyl group or a phenyl group having from 1 to 6 carbon atoms, and X¹ is a silylalkyl group represented by the following general formula (2) when i=1):

### Formula:

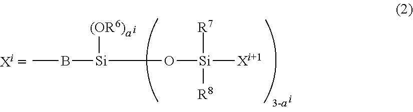

(wherein R⁶ is a hydrogen atom or an alkyl group having from 1 to 6 carbon atoms or a phenyl group, and R⁷ or R⁸ is a hydrogen atom or an alkyl group having from 1 to 6 carbon atoms or a phenyl group; B is a straight-chain or branched-chain alkylene group represented by CᵣH₂ᵣ; r is an integer from 2 to 20;
i represents the hierarchies of a silylalkyl group represented by Xⁱ, which is an integer from 1 to c when the number of hierarchies is c; the number of hierarchies c is an integer from 1 to 10; aⁱ is an integer from 0 to 2 when i is 1 and is a number less than 3 when i is 2 or greater; Xⁱ⁺¹ is a silylalkyl group when i is less than c and is a methyl group (—CH₃) when i=c).

Here, the monovalent hydrocarbon groups are the same groups as described above, and examples of the divalent hydrocarbon groups serving as A include but are not limited to alkylene groups having from 2 to 20 carbon atoms and aralkylene groups having from 8 to 22 carbon atoms. In addition, the silylalkyl group represented by X′ is known as a carbosiloxane dendrimer structure, an example of which is a group using a polysiloxane structure as a skeleton and having a highly branched structure in which siloxane bonds and silalkylene bonds are arranged alternately, as described in Japanese Unexamined Patent Application Publication No. 2001-213885.

It is preferable for at least 50 mol % of all of the R^{M1}, R^{D1}, and R^{T1} moieties to be monovalent hydrocarbon groups, and at least one group represented by —Z¹-(Q)n or a group represented by -A-^{D2}₂SiO)ₑ₁R^{D2}₂Si—Z¹-(Q)n is contained in the molecule. Further, in order to improve the refractive index, it is preferable for at least 30 mol % of all of the R^{M1}, R^{D1} and R^{T1} moieties to be groups selected from phenyl groups, condensed polycyclic aromatic groups, and groups containing condensed polycyclic aromatic groups, and it is particularly preferable for from 40 to 80 mol % to be phenyl groups or naphthyl groups. In addition, it is preferable for at least one of all of the R^{M}, R^{D}, and R^{R} moieties to be a hydrosilylation-reactive functional group, and it is particularly preferable for from 1 to 10 moieties to be silicon-bonded hydrogen atoms, alkenyl groups having from 2 to 10 carbon atoms, or acyloxy groups having from 3 to 12 carbon atoms.

a1 to d1 are respectively 0 or positive numbers, and a1+b1+c1+d1 is a number within the range from 2 to 500. In addition, the number of silicon atoms in the molecule, including siloxane portions that are branched via other divalent hydrocarbon groups, is within the range of from 2 to 1000. In particular, when the organic silicon compound of the present invention is used to post-treat the surface of one or more optical fine members selected from fluorescent microparticles, metal oxide microparticles, metal microparticles, nanocrystalline structures, and quantum dots with the objective of improving the dispersibility thereof, the number of silicon atoms in the organic silicon compound of the present invention is preferably determined so that a1+b1+c1+d1 is a number within the range of from 3 to 500 and the number of silicon atoms in the organic silicon compound is a number within the range of at most 500. Further, it is more preferable for a1+b1+c1+d1 to be a number within the range of from 5 to 200 and for the number of silicon atoms in the organic silicon compound to be a number within the range of at most 200 atoms. It is most preferable for a1+b1+c1+d1 to be a number within the range of from 7 to 100 and for the number of silicon atoms in the organic silicon compound to be a number within the range of at most 100 atoms. At this time, the number of silicon atoms having the functional groups (Q) in the average structural formula described above (x, excluding the silicon atoms in the functional groups (Q)) is preferably a number equal to at most ⅓ of the number of silicon atoms in the organic silicon compound. From the perspective of modifying the surface of the optical material, the number is more preferably at most ⅕, even more preferably at most 1/10, and particularly preferably at most 1/20 of the number of silicon atoms in the organic silicon compound.

Such an organic silicon compound of the present invention has an essentially hydrophobic main chain siloxane structure consisting of straight-chain or branched-chain siloxane bonds or silalkylene bonds represented by the following structural formulas (3-1) to (3-5), examples of which include organic silico compounds having functional groups (Q) selected from highly polar functional groups, hydroxyl group-containing groups, silicon atom-containing hydrolyzable groups, or metal salt derivatives thereof bonded to silicon atoms of the side chains (including structures that are branched via silalkylene bonds or the like) or terminals directly or via functional groups with a valency of (n+1).

### Formula:

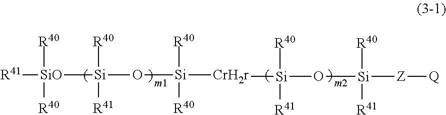

### Formula:

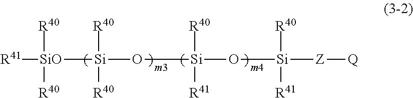

### Formula:

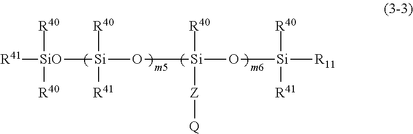

### Formula:

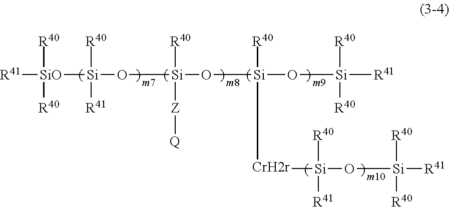

### Formula:

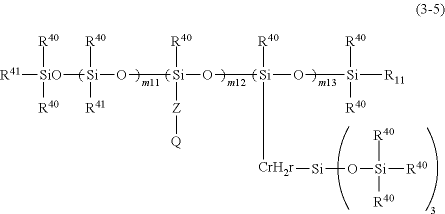

In the formula, —Z-Q is the same group as described above; the R⁴⁰ moieties; are independently methyl groups, phenyl groups, or naphthyl groups; and the R⁴¹ moieties are independently monovalent functional groups selected from hydrogen atoms, alkyl groups having from 1 to 20 carbon atoms, alkenyl groups having from 2 to 22 carbon atoms, phenyl groups, and naphthyl groups, and groups represented by —Z-Q.

In formula (3-1), m1 and m2 are respectively numbers equal to 1 or greater, wherein m1+m2 is preferably a number within the range of from 2 to 400, and m1 and m2 are particularly preferably numbers within the ranges of from 2 to 200 and from 1 to 100, respectively. In formula (3-1), r is a number within the range of from 1 to 20 and is preferably a number within the range of from 2 to 12. With the objective of improving the compounding stability in a hydrosilylation reaction-curable silicone resin, it is particularly preferable for at least one of the functional groups represented by R⁴¹ to be an alkenyl group having from 2 to 22 carbon atoms or a hydrogen atom. Further, with the objective of increasing the refractive index of the organic silicon compound, it is preferable for at least 40 mol % of all of the R⁴⁰ and R⁴¹ moieties to be phenyl groups or naphthyl groups. In addition, the number of silicon atoms to which the groups represented by —Z-Q are bonded is preferably a number equal to at most ⅓ the number of silicon atoms in the organic silicon compound represented by formula (3-1) (excluding the silicon atoms in the functional groups (Q)) and, from the perspective of modifying the optical material, is more preferably a number equal to at most ⅕ the number of silicon atoms in the organic silicon compound.

In formula (3-2), m3 and m4 are respectively numbers equal to 0 or greater, wherein m3+m4 is preferably a number within the range of from 0 to 400, and m3 and m4 are particularly preferably numbers within the ranges of from 2 to 300 and from 0 to 100, respectively. In addition, with the objective of improving the compounding stability in a hydrosilylation reaction-curable silicone resin, it is particularly preferable for at least one of the functional groups represented by R⁴¹ to be an alkenyl group having from 2 to 22 carbon atoms or a hydrogen atom. Further, with the objective of increasing the refractive index of the organic silicon compound, it is preferable for at least 40 mol % of all of the R⁴⁰ and R⁴¹ moieties to be phenyl groups or naphthyl groups. In addition, the number of silicon atoms to which the groups represented by —Z-Q are bonded is preferably a number equal to at most ⅓ the number of silicon atoms in the organic silicon compound represented by formula (3-2) (excluding the silicon atoms in the functional groups (Q)) and, from the perspective of modifying the optical material, is more preferably a number equal to at most ⅕ the number of silicon atoms in the organic silicon compound.

In formula (3-3), m5 is a number equal to 0 or greater, m6 is a number equal to 1 or greater, wherein m5+m6 is preferably a number within the range of from 1 to 400, and m5 and m4 are particularly preferably numbers within the ranges of from 0 to 300 and from 1 to 10, respectively. In addition, with the objective of improving the compounding stability in a hydrosilylation reaction-curable silicone resin, it is particularly preferable for at least one of the functional groups represented by R⁴¹ to be an alkenyl group having from 2 to 22 carbon atoms or a hydrogen atom. Further, with the objective of increasing the refractive index of the organic silicon compound, it is preferable for at least 40 mol % of all of the R⁴⁰ and R⁴¹ moieties to be phenyl groups or naphthyl groups. In addition, the number of silicon atoms to which the groups represented by —Z-Q are bonded is preferably a number equal to at most ⅓ the number of silicon atoms in the organic silicon compound represented by formula (3-3) (excluding the silicon atoms in the functional groups (Q)) and, from the perspective of modifying the optical material, is more preferably a number equal to at most ⅕ the number of silicon atoms in the organic silicon compound.

In formula (3-4), m7 is a number equal to 0 or greater, m8 and m9 are respectively numbers equal to 1 or greater, and m10 is a number within the range of from 1 to 50. It is preferable for m7+m8+m9 to be a number within the range of from 2 to 400. It is also preferable for m7 to be a number within the range of from 2 to 200 and for m8 or m9 to respectively be a number within the range of from 1 to 100. In formula (3-4), r is a number within the range of from 1 to 20 and is preferably a number within the range of from 2 to 12. In addition, with the objective of improving the compounding stability in a hydrosilylation reaction-curable silicone resin, it is particularly preferable for at least one of the functional groups represented by R⁴¹ to be an alkenyl group having from 2 to 22 carbon atoms or a hydrogen atom. Further, with the objective of increasing the refractive index of the organic silicon compound, it is preferable for at least 40 mol % of all of the R⁴⁰ and R⁴¹ moieties to be phenyl groups or naphthyl groups. In addition, the number of silicon atoms to which the groups represented by —Z-Q are bonded is preferably a number equal to at most ⅓ the number of silicon atoms in the organic silicon compound represented by formula (3-4) (excluding the silicon atoms in the functional groups (Q)) and, from the perspective of modifying the optical material, is more preferably a number equal to at most ⅕ the number of silicon atoms in the organic silicon compound.

The structure represented by formula (3-5) has a carbosiloxane dendrimer structure in the molecule, wherein m11 is a number equal to 0 or greater, m12 is a number equal to 1 or greater, and m13 is a number equal to 1 or greater. It is preferable for m11+m12+m13 to be a number within the range of from 2 to 400, and it is particularly preferable for m11 to be a number within the range of from 2 to 200 and for m8 or m9 to respectively be a number within the range of from 1 to 100. In formula (3-5), r is a number within the range of from 1 to 20 and is preferably a number within the range of from 2 to 12. In addition, with the objective of improving the compounding stability in a hydrosilylation reaction-curable silicone resin, it is particularly preferable for at least one of the functional groups represented by R⁴¹ to be an alkenyl group having from 2 to 22 carbon atoms or a hydrogen atom. Further, with the objective of increasing the refractive index of the organic silicon compound, it is preferable for at least 40 mol % of all of the R⁴⁰ and R⁴¹ moieties to be phenyl groups or naphthyl groups. In addition, the number of silicon atoms to which the groups represented by —Z-Q are bonded is preferably a number equal to at most ⅓ the number of silicon atoms in the organic silicon compound represented by formula (3-5) (excluding the silicon atoms in the functional groups (Q)) and, from the perspective of modifying the optical material, is more preferably a number equal to at most ⅕ the number of silicon atoms in the organic silicon compound.

The production method of the organic silicon compound of the present invention is not particularly limited, but the compound can be obtained, for example, by reacting a siloxane raw material having a reactive group such as an alkenyl group, an amino group, a halogen atom, or a hydrogen atom in the molecule and preferably having a refractive index of at least 1.45 and an organic compound or an organic silicon compound having a group that is reactive with the functional groups (Q) described above in the presence of a catalyst. By adjusting the reaction ratio of the structure of the siloxane raw material and the compound having the functional groups (Q), it is possible to adjust the number of functional groups introduced into the molecule and to leave behind hydrosilylation-reactive functional groups such as alkenyl groups.

In the curable silicone composition of the present invention, component (B) preferably consists of metal oxide microparticles surface-treated by component (C). Examples of methods for treating the surface of component (B) include a method of spraying component (C) or a solution thereof (containing a product dispersed in an organic solvent) at a temperature from room temperature to 200° C. while stirring component (B) with an agitator and then drying the mixture; a method of mixing the metal component (B) and component (C) or a solution thereof in an agitator (including a grinding device such as a ball mill or a jet mill, an ultrasonic dispersing device, and the like) and then drying the mixture; and a treatment method of adding a treatment agent to a solvent, dispersing a powder so that the powder is adsorbed by the surface, and then drying and sintering the mixture. Another example is a method of adding the other silicone components constituting the curable silicone of the present invention (component (A) and the like), component (B), and component (C) and then treating the surface in-situ (integral blending method). When treating the surface of component (B), the amount of component (C) that is added is preferably from 0.1 to 500 parts by mass, particularly preferably from 1.0 to 250 parts by mass, and most preferably within the range of from 5.0 to 100 parts by mass per 100 parts by weight of component (B). In particular, when component (B) is an optical fine member with a small particle size of at most a few tens of nm, it is preferable to add at least 100 parts by mass of component (C) to 100 parts by mass of component (B).

In the surface treatment methods described above, the device used to stir components (B) and (C) is not particularly limited, and two or more types of dispersing devices may also be used in separate stages. Specific examples of devices used for dispersion and stirring include a homo mixer, a paddle mixer, a Henschel mixer, a line mixer, a homo disper, a propeller agitator, a vacuum kneader, a homogenizer, a kneader, a dissolver, a high-speed dispenser, a sand mill, a roll mill, a ball mill, a tube mill, a conical mill, an oscillating ball mill, a high swing ball mill, a jet mill, an attritor, a dyno mill, a GP mill, a wet atomization device (Altimizer or the like manufactured by Sugino Machines), an ultrasonic dispersion device (ultrasonic homogenizer), a bead mill, a Banbury mixer, a stone mortar mill, and a grindstone-type pulverizer. In particular, in order to disperse inorganic particles into fine particles with an average particle size of at most 100 nm, dispersion with an ultrasonic dispersion device or bead mill which promotes dispersion by means of the shearing force caused by the friction of minute beads is preferable. Examples of such a bead mill include the “Ultra Apex Mill” (trade name) manufactured by Kotobuki Industries (Ltd.) and the “Star Mill” (trade name) manufactured by Ashizawa Fine Tech (Ltd.). The beads that are used are preferably glass beads, zirconia beads, alumina beads, magnetic beads, styrene beads, or the like. When an ultrasonic dispersion device is used, it is preferable to use an ultrasonic homogenizer with a rated output of at least 300 W. These ultrasonic homogenizers are commercially available from Nippon Seiki Co., Ltd., Mitsui Electric Co., Ltd., or the like.

Further, when component (C) is an organic silicon compound having at least one condensation-reactive functional group or hydrosilylation-reactive functional group in the molecule, the component may be used not only as a surface treatment agent for component (B), but also as part of the main agent of the composition, as with component (A). Specifically, following a method of adding the aforementioned organic silicon compound having at least one condensation-reactive functional group or hydrosilylation-reactive functional group in the molecule as the curable silicone composition of the present invention, a reactive silicone serving as a cross-linking agent, a substrate, and a curing reaction catalyst and treating the surface of the optical material in-situ (integral blending method), the entire composition may be cured. In particular, since the organic silicon compound of the present invention has excellent compounding stability with respect to silicone materials, the dispersibility and thermal stability of the substrate in the cured product are particularly favorable after the curing reaction when the material has a high refractive index of at least 1.50, which yields the advantage that the entire cured product is uniform and has a high refractive index.

For example, preparing a curable silicone composition containing component (B) surface-treated by the organic silicon compound of the present invention by uniformly mixing component (A), component (B), component (C) having at least one alkenyl group or acyloxy group in the molecule, an organopolysiloxane having at least two silicon-bonded hydrogen atoms in each molecule, and a hydrosilylation reaction catalyst and curing the composition by heating or the like is included in the preferred embodiments of the present invention.

<Curable Silicone Composition>

The curable silicone composition of the present invention contains component (A), component (B), and, preferably, component (C), but since the composition is curable by means of a hydrosilylation reaction, the composition typically further contains (D) an organopolysiloxane having at least two hydrosilylation-reactive functional groups in each reactive molecule and (E) a hydrosilylation reaction catalyst.

Examples of the makeup of the curable silicone composition are as follows, depending on whether component (A) is (A1) having alkenyl groups or (A2) having silicon-bonded atoms.

For example, when component (A) has alkenyl groups, an example is a curable silicone composition comprising at least:

(A1) an organopolysiloxane represented by the average unit formula:

(R¹¹₃SiO_{1/2})ₐ(R¹¹₂SiO_{2/2})_{b}(R²¹SiO_{3/2})_{c}(SiO_{4/2})_{d}

(wherein the R¹¹ moieties are alkyl groups, alkenyl groups, or phenyl groups; the R²¹ moieties are groups represented by R¹¹, condensed polycyclic aromatic groups, or groups including a condensed polycyclic aromatic group, provided that at least one of the R¹¹ and R²¹ moieties in the molecule is an alkenyl group and at least 50 mol % of the R²¹ moieties in the molecule are naphthyl groups; and a, b, c, and d are numbers satisfying the formulae: 0.01≦a≦0.8, 0≦b≦0.5, 0.2≦c≦0.9, 0≦d<0.2, and a+b+c+d=1);
(B) metal oxide microparticles with an average particle size of at most 200 nm and a refractive index of at least 1.55;
(C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1) (n is a number equal to 1 or greater) and
having at least one structure in the molecule in which the silicon atoms are bonded to any siloxane unit represented by R³¹₃SiO_{1/2}, R³¹₂SiO_{2/2}, R³⁷SiO_{3/2}, and SiO_{4/2} (wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1));
(D1) an organopolysiloxane having at least two silicon-bonded hydrogen atoms in each molecule; and
(E) a hydrosilylation reaction catalyst.

The organopolysiloxane of component (A1) is represented by the average unit formula:

(R¹¹₃SiO_{1/2})ₐ(R¹¹₂SiO_{2/2})_{b}(R²¹SiO_{3/2})_{c}(SiO_{4/2})_{d}

In the formula, the R¹¹ moieties are alkyl groups, alkenyl groups, or phenyl groups. Examples of the alkyl group of R¹¹ include the same groups described for R¹. Of these, a methyl group is preferable. Examples of the alkenyl group of R¹¹ include the same groups described for R¹. Of these, a vinyl group is preferable.

Moreover, in the formula, R²¹ is the group represented by R¹¹, or is a condensed polycyclic aromatic group or a group including a condensed polycyclic aromatic group. Examples of the alkyl group of R²¹ include the same groups described for R¹. Examples of the alkenyl group of R²¹ include the same groups described for R¹. Examples of the condensed polycyclic aromatic group of R²¹ include a naphthyl group, an anthracenyl group, a phenanthryl group, a pyrenyl group, and such condensed polycyclic aromatic groups where a hydrogen atom is replaced by an alkyl group such as a methyl group, an ethyl group, and the like; by an alkoxy group such as a methoxy group, an ethoxy group, and the like; or by a halogen atom such as a chlorine atom, a bromine atom, and the like. The condensed polycyclic aromatic group of R²¹ is preferably the naphthyl group. Examples of the group including a condensed polycyclic aromatic group of R²¹ include alkyl groups including a condensed polycyclic aromatic group such as a naphthyl ethyl group, a naphthyl propyl group, an anthracenyl ethyl group, a phenanthryl ethyl group, a pyrenyl ethyl group, and the like; and such groups where a hydrogen atom in the condensed polycyclic aromatic group is replaced by an alkyl group such as a methyl group, an ethyl group, and the like; by an alkoxy group such as a methoxy group, an ethoxy group, and the like; or by a halogen atom such as a chlorine atom, a bromine atom, and the like.

Furthermore, in the formula, at least one of the R₁₁ or R²¹ moieties in one molecule is an alkenyl group. Moreover, in the formula, at least one of the R²¹ moieties in one molecule is a condensed polycyclic aromatic group or a group including a condensed polycyclic aromatic group. Preferably at least 50 mol % of the R²¹ moieties in one molecule are condensed polycyclic aromatic groups or groups including condensed polycyclic aromatic groups.

Further, in the formula, a, b, c, and d are numbers that satisfy the formulae: 0.01≦a≦0.8, 0≦b≦0.5, 0.2≦c≦0.9, 0≦d<0.2, and a+b+c+d=1. Preferably, a, b, c, and d are numbers that satisfy the formulae: 0.05≦a≦0.7, 0≦b≦0.4, 0.3≦c≦0.9, 0≦d<0.2, and a+b+c+d=1. Particularly preferably, a, b, c, and d are numbers that satisfy the formulae: 0.1≦a≦0.6, 0≦b≦0.3, 0.4≦c≦0.9, 0≦d<0.2, and a+b+c+d=1. When a is less than the lower limit of the range described above, handling and processability of the obtained composition declines. On the other hand, transparency of the obtained cured product declines if a exceeds the upper limit of the range described above. Further, stickiness of the obtained cured product occurs when b exceeds the upper limit of the range described above. Further, refractive index of the obtained cured product may markedly decline if c is less than the lower limit of the range described above. On the other hand, the obtained cured product becomes excessively rigid and brittle if c exceeds the upper limit of the range described above. Further, the obtained cured product becomes extremely rigid and brittle if d exceeds the upper limit of the range described above.

Components (B) and (C) are the same components as described above.

No particular limitation is placed on the organopolysiloxane of the component (D1) as long as the organopolysiloxane has a silicon-bonded hydrogen atom. Examples of the bond positions of the silicon-bonded hydrogen atoms in the component (D1) are molecular chain terminals and/or molecular side chains. The other groups bonded to the silicon atom in the component (D1) are exemplified by alkyl groups such as a methyl group, an ethyl group, a propyl group, a butyl group, a pentyl group, a hexyl group, a heptyl group, and the like; aryl groups such as a phenyl group, a tolyl group, a xylyl group, a naphthyl group, and the like; aralkyl groups such as a benzyl group, a phenethyl group, and the like; and halogenated alkyl groups such as a chloromethyl group, a 3-chloropropyl group, a 3,3,3-trifluoropropyl group, and the like; and such other groups are preferably the methyl group or phenyl group. The component (B) may have a straight, branched, cyclic, net-like, or a partially branched straight chain molecular structure.

This type of component (D1) organopolysiloxane is exemplified by a methylhydrogenpolysiloxane capped at both molecular terminals with trimethylsiloxy groups, a copolymer of dimethylsiloxane and methyl hydrogen siloxane capped at both molecular terminals with trimethylsiloxy groups, a dimethylsiloxane-methylhydrogensiloxane methylphenylsiloxane copolymer capped at both molecular terminals with trimethylsiloxy groups, a dimethylpolysiloxane capped at both molecular terminals with dimethylhydrogensiloxy groups, a dimethylsiloxanemethylphenylsiloxane copolymer capped at both molecular terminals with dimethylhydrogensiloxy groups, a methylphenylpolysiloxane capped at both molecular terminals with dimethylhydrogensiloxy groups, organopolysiloxane copolymers composed of siloxane units represented by the general formula R′₃SiO_{1/2} and siloxane units represented by the general formula R′₂HSiO_{1/2} and siloxane units represented by the formula SiO_{4/2}, organopolysiloxane copolymers composed of siloxane units represented by the general formula R′₂HSiO_{1/2} and siloxane units represented by the formula SiO_{4/2}, organopolysiloxane copolymers composed of siloxane units represented by the general formula R′HSiO_{2/2}, organopolysiloxane copolymers composed of siloxane units represented by the general formula R′SiO_{3/2} or siloxane units represented by the formula HSiO_{3/2}, and mixtures of two or more such organopolysiloxanes. Furthermore, R′ in the formula is an alkyl group such as a methyl group, an ethyl group, a propyl group, a butyl group, a pentyl group, a hexyl group, a heptyl group, and the like; an aryl group such as a phenyl group, a tolyl group, a xylyl group, naphthyl group, and the like; an aralkyl group such as a benzyl group, a phenethyl group, and the like; or a halogenated alkyl group such as a chloromethyl group, a 3-chloropropyl group, a 3,3,3-trifluoropropyl group, and the like.

Examples of the component (E) hydrosilylation reaction catalyst include platinum-based catalysts, rhodium-based catalysts, and palladium-based catalysts. Platinum-based catalysts are preferred due to the ability to remarkably promote curing of the present composition. Examples of the platinum-based catalyst include a platinum fine powder, chloroplatinic acid, an alcohol solution of chloroplatinic acid, a platinum-alkenylsiloxane complex, a platinum-olefin complex and a platinum-carbonyl complex, with a platinum-alkenylsiloxane complex being preferred.

Another example of this composition when component (A) has silicon-bonded hydrogen atoms, for example, is a curable silicone composition comprising at least:

(A2) an organopolysiloxane represented by the average unit formula:

(R¹²₃SiO_{1/2})ₐ(R¹²₂SiO_{2/2})_{b}(R²²SiO_{3/2})_{c}(SiO_{4/2})_{d}

(wherein the R¹² moieties are alkyl groups, phenyl groups, or hydrogen atoms; the R²² moieties are groups represented by R¹², condensed polycyclic aromatic groups, or groups including a condensed polycyclic aromatic group, provided that at least one of the R¹² and R²² moieties in the molecule is a hydrogen atom and at least 50 mol % of the R²² moieties in the molecule are naphthyl groups; and a, b, c, and d are numbers satisfying the formulae: 0.01≦a≦0.8, 0≦b≦0.5, 0.2≦c≦0.9, 0≦d<0.2, and a+b+c+d=1);
(B) metal oxide microparticles with an average particle size of at most 200 nm and a refractive index of at least 1.55;
(C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1) (n is a number equal to 1 or greater) and
having at least one structure in the molecule in which the silicon atoms are bonded to any siloxane unit represented by R³¹₃SiO_{1/2}, R³¹₂SiO_{2/2}, R³¹SiO_{3/2}, and SiO_{4/2} (wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1));
(D2) an organopolysiloxane having at least two alkenyl groups in each molecule; and
(E) a hydrosilylation reaction catalyst.

The organopolysiloxane of component (A2) is represented by the average unit formula:

(R¹²₃SiO_{1/2})ₐ(R¹²₂SiO_{2/2})_{b}(R²²SiO_{3/2})_{c}(SiO_{4/2})_{d}

In the formula, the R¹² moieties are alkyl groups, phenyl groups or hydrogen atoms. Examples of the alkyl group of R¹² include the same groups described for R¹. Of these, the methyl group is preferable.

Moreover, in the formula, R²² is represented by R¹² or a condensed polycyclic aromatic group or a group including a condensed polycyclic aromatic group. Examples of the alkyl group of R²² include the same groups described for R¹. Examples of the condensed polycyclic aromatic group of R²² include a naphthyl group, an anthracenyl group, a phenanthryl group, a pyrenyl group, and such condensed polycyclic aromatic groups where a hydrogen atom is replaced by an alkyl group such as a methyl group, an ethyl group, and the like; by an alkoxy group such as a methoxy group, an ethoxy group, and the like; or by a halogen atom such as a chlorine atom, a bromine atom, and the like. The condensed polycyclic aromatic group is preferably the naphthyl group. Examples of the group including a condensed polycyclic aromatic group of R²¹ include alkyl groups including a condensed polycyclic aromatic group such as a naphthyl ethyl group, a naphthyl propyl group, an anthracenyl ethyl group, a phenanthryl ethyl group, a pyrenyl ethyl group, and the like; and such groups where a hydrogen atom in the condensed polycyclic aromatic group is replaced by an alkyl group such as a methyl group, an ethyl group, and the like; by an alkoxy group such as a methoxy group, an ethoxy group, and the like; or by a halogen atom such as a chlorine atom, a bromine atom, and the like.

Furthermore, in the formula, at least one of the R¹² or R²² moieties in one molecule is the hydrogen atom. Moreover, in the formula, at least one R²² moiety in one molecule is a condensed polycyclic aromatic group or a group including a condensed polycyclic aromatic group. Preferably at least 50 mol % of the R²² moieties in one molecule are condensed polycyclic aromatic groups or groups including a condensed polycyclic aromatic group.

Further, in the formula, a, b, c, and d are numbers that satisfy the formulae: 0.01≦a≦0.8, 0≦b≦0.5, 0.2≦c≦0.9, 0 d<0.2, and a+b+c+d=1. Preferably, a, b, c, and d are numbers that satisfy the formulae: 0.05≦a≦0.7, 0≦b≦0.4, 0.3≦c≦0.9, 0≦d<0.2, and a+b+c+d=1. Particularly preferably, a, b, c, and d are numbers that satisfy the formulae: 0.1≦a≦0.6, 0≦b≦0.3, 0.4≦c≦0.9, 0 d<0.2, and a+b+c+d=1. When a is less than the lower limit of the range described above, handling and processability of the obtained composition declines. On the other hand, transparency of the obtained cured product declines if a exceeds the upper limit of the range described above. Further, stickiness of the obtained cured product occurs when b exceeds the upper limit of the range described above. Further, refractive index of the obtained cured product may markedly decline if c is less than the lower limit of the range described above. On the other hand, the obtained cured product becomes excessively rigid and brittle if c exceeds the upper limit of the range described above. Further, the obtained cured product becomes extremely rigid and brittle if d exceeds the upper limit of the range described above.

No particular limitation is placed on the organopolysiloxane of the component (D2) as long as it has an alkenyl group. Examples of the alkenyl groups in the component (D2) include vinyl groups, allyl groups, butenyl groups, pentenyl groups, hexenyl groups, and heptenyl groups. Of these, vinyl groups are preferable. Non-alkenyl groups in the component (D2) bonding to the silicon atom are exemplified by alkyl groups such as a methyl group, an ethyl group, a propyl group, a butyl group, a pentyl group, a hexyl group, a heptyl group, and the like; aryl groups such as a phenyl group, a tolyl group, a xylyl group, a naphthyl group, and the like; aralkyl groups such as a benzyl group, a phenethyl group, and the like; and halogenated alkyl groups such as a chloromethyl group, a 3-chloropropyl group, a 3,3,3-trifluoropropyl group, and the like; and such non-alkenyl groups are preferably the methyl group or phenyl group. The component (D2) may have a straight, branched, cyclic, net-like, or a partially branched straight chain molecular structure.

This type of organopolysiloxane of the component (D2) is exemplified by a copolymer of dimethylsiloxane and methylvinylsiloxane capped at both molecular terminals with trimethylsiloxy groups, methylvinylpolysiloxane capped at both molecular terminals with trimethylsiloxy groups, dimethylsiloxanemethylvinylsiloxanemethylphenylsiloxane copolymer capped at both molecular terminals with trimethylsiloxy groups, dimethylpolysiloxane capped at both molecular terminals with dimethylvinylsiloxy groups, methylvinylpolysiloxane capped at both molecular terminals with dimethylvinylsiloxy groups, copolymers of dimethylsiloxane and methylvinylsiloxane capped at both molecular terminals with dimethylvinylsiloxy groups, dimethylsiloxanemethylvinylsiloxanemethylphenylsiloxane copolymer capped at both molecular terminals with dimethylvinylsiloxy groups, organopolysiloxane copolymers composed of siloxane units represented by the general formula R₃SiO_{1/2} and siloxane units represented by the general formula R′₂R″SiO_{1/2} and siloxane units represented by the formula SiO_{4/2}, organopolysiloxane copolymers composed of siloxane units represented by the general formula R′₂R″SiO_{1/2} and siloxane units represented by the formula SiO_{4/2}, organopolysiloxane copolymers composed of siloxane units represented by the general formula R′R″SiO_{2/2} and siloxane units represented by the general formula R′SiO_{3/2} and siloxane units represented by the general formula R″SiO_{3/2}, and mixtures of two or more such organopolysiloxanes. Furthermore, R′ in the formula is synonymous with the groups described above. Furthermore, R″ in the formula is an alkenyl group and is exemplified by a vinyl group, an allyl group, a butenyl group, a pentenyl group, a hexenyl group, and a heptenyl group.

Components (B) and (C) are the same components as described above, and an example of the (E) hydrosilylation reaction catalyst is the same catalyst as described above.

In this composition, the content of the organopolysiloxane having silicon-bonded hydrogen atoms is not particularly limited, but the amount preferably results in a mole ratio of silicon-bonded hydrogen atoms relative to alkenyl groups in the composition being within the range of from 0.1 to 5 and particularly preferably within the range of from 0.5 to 2.

In the present composition, the content of component (E) is not particularly limited as long as the curing of the composition can be accelerated. Specifically, the content is preferably an amount with which the catalyst metal in component (E) is within the range of from 0.01 to 500 ppm, even more preferably within the range of from 0.01 to 100 ppm, and yet even more preferably within the range of from 0.01 to 50 ppm in weight units with respect to the above composition.

The present composition may also contain an adhesion-imparting agent for improving the adhesion of the composition. Preferred adhesion-imparting agents are organosilicon compounds having at least one alkoxy group bonded to a silicon atom in one molecule. This alkoxy group is exemplified by a methoxy group, an ethoxy group, a propoxy group, a butoxy group, and a methoxyethoxy group; and the methoxy group is particularly preferred. Moreover, non-alkoxy groups bonded to a silicon atom of this organosilicon compound are exemplified by substituted or non-substituted monovalent hydrocarbon groups such as alkyl groups, alkenyl groups, aryl groups, aralkyl groups, halogenated alkyl groups, and the like; glycidoxyalkyl groups such as a 3-glycidoxypropyl group, a 4-glycidoxybutyl group, and the like; epoxy group-containing monovalent organic groups such as epoxycyclohexylalkyl groups (such as a 2-(3,4-epoxycyclohexyl)ethyl group, a 3-(3,4-epoxycyclohexyl)propyl group, and the like) and oxiranylalkyl groups (such as a 4-oxiranylbutyl group, an 8-oxiranyloctyl group, and the like); acrylic group-containing monovalent organic groups such as a 3-methacryloxypropyl group and the like; and a hydrogen atom. This organosilicon compound preferably has a silicon-bonded alkenyl group or silicon-bonded hydrogen atom. Moreover, due to the ability to impart good adhesion with respect to various types of substrates, this organosilicon compound preferably has at least one epoxy group-containing monovalent organic group in one molecule. This type of organosilicon compound is exemplified by organosilane compounds, organosiloxane oligomers and alkyl silicates. Molecular structure of the organosiloxane oligomer or alkyl silicate is exemplified by a linear structure, partially branched linear structure, branched chain structure, ring-shaped structure, and net-shaped structure. A linear chain structure, branched chain structure, and net-shaped structure are particularly preferred. This type of organosilicon compound is exemplified by silane compounds such as 3-glycidoxypropyltrimethoxysilane, 2-(3,4-epoxycyclohexyl)ethyltrimethoxysilane, 3-methacryloxy propyltrimethoxysilane, and the like; siloxane compounds having at least one of silicon-bonded alkenyl groups or silicon-bonded hydrogen atoms, and at least one silicon-bonded alkoxy group in one molecule; mixtures of a silane compound or siloxane compound having at least one silicon-bonded alkoxy group and a siloxane compound having at least one silicon-bonded hydroxyl group and at least one silicon-bonded alkenyl group in one molecule; and methyl polysilicate, ethyl polysilicate, and epoxy group-containing ethyl polysilicate.

In the present composition, the content of this adhesion-imparting agent is not particularly limited, but is preferably within the range of from 0.01 to 10 parts by weight per total of 100 parts by weight of the composition.

A reaction inhibitor, for example, an alkyne alcohol such as 2-methyl-3-butyn-2-ol, 3,5-dimethyl-1-hexyn-3-ol or 2-phenyl-3-butyn-2-ol; an ene-yne compound such as 3-methyl-3-penten-1-yne or 3,5-dimethyl-3-hexen-1-yne; or 1,3,5,7-tetramethyl-1,3,5,7-tetravinylcyclotetrasiloxane, 1,3,5,7-tetramethyl-1,3,5,7-tetrahexenylcyclotetrasiloxane or a benzotriazole may be incorporated as an optional component in the present composition.

In the present composition, the content of the reaction inhibitor is not limited, but is preferably from 0.0001 to 5 parts by weight per 100 parts by weight of the present composition.

In addition, the composition of the present invention may also contain one or more optical fine members selected from fluorescent microparticles, metal microparticles, nanocrystalline structures, and quantum dots as additional optional components. It is preferable for some or all of these optical fine members to be surface-treated with component (C). Similarly, as long as the object of the present invention is not inhibited, this composition may also contain inorganic powders such as fumed silica, sedimentary silica, molten silica, fumed titanium oxide, quartz powder, glass powder (glass beads), aluminum hydroxide, magnesium hydroxide, silicon nitride, aluminum nitride, boron nitride, silicon carbide, calcium silicate, magnesium silicate, diamond particles, and carbon nanotubes; or organic resin fine powders such as polymethacrylate resins, and it is preferable for some or all of these materials to be surface-treated with component (C).

<Component (F): Fluorescent Material>

It is particularly preferable for the composition of the present invention to contain fluorescent microparticles. This fluorescent material is exemplified by substances widely used in light emitting diodes (LED), such as yellow, red, green, and blue light-emitting phosphors such as oxide type phosphors, oxynitride type phosphors, nitride type phosphors, sulfide type phosphors, oxysulfide type phosphors, and the like. Examples of oxide fluorescent substances include yttrium, aluminum, and garnet-type YAG green to yellow light-emitting fluorescent substances containing cerium ions, terbium, aluminum, and garnet-type TAG yellow light-emitting fluorescent substances containing cerium ions, and silicate green to yellow light-emitting fluorescent substances containing cerium or europium ions. Examples of oxynitride fluorescent substances include silicon, aluminum, oxygen, and nitrogen-type SiAlON red to green light-emitting fluorescent substances containing europium ions. Examples of nitride fluorescent substances include calcium, strontium, aluminum, silicon, and nitrogen-type cousin red light-emitting fluorescent substances containing europium ions. Examples of sulfide fluorescent substances include ZnS green light-emitting fluorescent substances containing copper ions or aluminum ions. Examples of oxysulfide fluorescent substances include Y2O2S red light-emitting fluorescent substances containing europium ions. These phosphors may be used as one type or as a mixture of two or more types.

In this composition, the content of the fluorescent microparticles is not particularly limited but is within the range of from 0.1 to 70 M. % and is preferably within the range of from 1 to 20 wt. % in the composition.

As long as the object of the present invention is not inhibited, this composition may also contain additives such as antioxidants, denaturing agents, surfactants, dyes, pigments, anti-discoloration agents, ultraviolet absorbers, heat resistant agents, flame retardancy imparting agents, and solvents as other optional components.

The curing of this composition progresses at room temperature or while heating, but the composition is preferably heated in order to cure the composition quickly. The heating temperature is preferably from 50 to 200° C. Such a composition of the present invention may be used as an adhesive, a potting agent, a protective agent, a coating agent, or an underfill agent for electrical/electronic use. In particular, the composition is particularly suitable as an adhesive, a potting agent, a protective agent, a coating agent, or an underfill agent, in a semiconductor element for optical applications due to the high optical transmittance of the composition.

The cured product of the present invention will now be described in detail.

The cured product of the present invention is formed by curing the aforementioned curable silicone composition. The shape of the cured product of the present invention is not particularly limited, and examples include a sheet-shaped product and a film-shaped product. The cured product of the present invention can be handled alone or in a state in which it covers or seals an optical semiconductor element or the like.

The optical semiconductor device of the present invention will now be explained in detail.

This device is characterized in that an optical semiconductor element is covered or sealed by a cured product of the curable silicone composition described above. An example of this optical semiconductor element is a light emitting diode (LED) chip. Examples of such an optical semiconductor device include a light emitting diode (LED), a photocoupler, and a CCD.

An optical semiconductor device can be produced with the curable silicone composition described above by applying the composition to an appropriate thickness with a method such as casting, spin coating, or roll coating or covering an optical semiconductor element by potting and then heating and drying at 50 to 200° C.

### EXAMPLES

The curable silicone composition, cured product, and optical semiconductor device of the present invention will be described in detail hereinafter using examples. In the compositions described below, Vi represents a vinyl group, Me represents a methyl group, Ph represents a phenyl group, and Np represents a naphthyl group. The refractive index was measured at 25° C. and 590 nm for liquid products and at 25° C. and 633 nm for cured products. The transmittance indicates the transmittance of light with a wavelength of 580 nm at a thickness of 10 μm. The end points of the reactions in the synthesis examples were confirmed by collecting part of the sample and confirming the consumption of reactive functional groups by infrared spectrophotometry (hereafter called “IR analysis”).

In the dispersion of the metal oxide microparticles, the definition of the average particle size is as follows.

### <Average Particle Size>

The average particle size of the metal oxide microparticles in the dispersion is the cumulant average particle size measured using a Zeta-potential and Particle Size Analyzer ELSZ-2 (manufactured by Otsuka Electronics Co., Ltd.).

### Synthesis Examples

First, 450 g (125.5 millimoles) of a phenylmethylpolysiloxane capped at both terminals with vinyl dimethylsiloxane groups represented by the average structural formula: ViMe₂Si(OSiMePh)₂₅OSiMe₂Vi was mixed with a complex of platinum and 1,3-divinyltetramethyldisiloxane in an amount so that the platinum metal content was 2 ppm with respect to the total amount of the reaction mixture. After the mixture was heated to 90° C., 35.4 g (125.5 millimoles) of a compound represented by the average structural formula: HMe₂SiOSiMe₂C₂H₄Si(OMe)₃ was dripped into the mixture. After the mixture was stirred for one hour at 100° C., part of the mixture was sampled and subjected to IR analysis, revealing that the SiH groups were completely consumed. The low boiling point substances were removed by heating under reduced pressure to obtain 483 g of a silethylene silicone with the following average structure (surface treatment agent No. 1) as a clear, colorless liquid (yield: 99.5%). Formula:

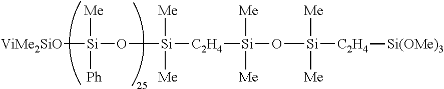

The refractive index was 1.5360.

### <Example of Production of Barium Titanate Dispersion>

First, 30 g of barium titanate with a primary particle size of 20 nm, 3.0 g of diphenylmethylsilanol (MeSiPh₂OH), and 16.5 g of toluene were mixed well to form a paste. Next, the toluene was removed at room temperature under reduced pressure, and the mixture was plated in an oven at 150° C. and treated by leaving the mixture to stand for one hour to obtain barium titanate treated with diphenylmethylsilanol.

Next, 9.9 g of this barium titanate treated with diphenylmethylsilanol, 0.9 g of the surface treatment agent No. 1 described above, and 90 g of toluene were mixed and treated for 1.5 hours with an ultrasonic dispersion device in the same manner as in Example 1 to obtain a dispersion 1 with a cumulant average particle size of 100.9 nm.

### <Example of Production of Titanium Oxide Dispersion>

First, 6 g of titanium oxide with a primary particle size of 35 nm, 1.8 g of the surface treatment agent No. 1 described above, and 90 g of toluene were mixed in a beaker. The tip of an ultrasonic dispersion device (same as described above) with an output of 300 W was immersed in this mixture, and the beaker was cooled with ice water and irradiated with ultrasonic waves for 90 minutes while ensuring that the liquid temperature did not exceed 40° C. After the beaker was left to stand for 24 hours, coarse particles were removed from the dispersion using decantation and a membrane filter with an airhole size of 0.2 μm to obtain a dispersion 2. When the resulting titanium oxide dispersion was measured with a particle size measuring device using a dynamic light scattering method, the cumulant average particle size was 138.0 nm.

### Examples 1 to 3, Comparative Examples 1 to 3

### Evaluation of the Curable Organopolysiloxane Composition and the Cured Product

With the compositions illustrated in Table 1, dispersion 1 of barium titanate in an amount so that the barium titanate content was a prescribed amount, a vinyl functional polyorganosiloxane, and an SiH functional polyorganosiloxane were mixed. Next, a 1,3-divinyltetramethyl disiloxane platinum complex was mixed at an amount in which the platinum metal was 2 ppm with respect to the solid content in weight units so as to prepare a solution of a curable organopolysiloxane composition.

This solution of the curable organopolysiloxane was dripped onto a glass plate and dried for one hour at 70° C. After the solvent was removed, the mixture was heated for 2 hours at 150° C. to obtain a cured product.

The makeup of the cured organopolysiloxane compositions and the evaluation results of the cured products are shown in Table 1. The SiH/Vi ratio in the table represents the number of moles of silicon-bonded hydrogen atoms in the SiH functional polyorganosiloxane with respect to a total of 1 mole of the dispersion and vinyl groups in the vinyl functional polyorganosiloxane in the curable organopolysiloxane composition.

### <Refractive Index of the Cured Product>

The refractive index of the cured product of the curable silicone composition formed with the method described above was measured using a prism coupler method at room temperature. A 632.8 nm (approximately 633 nm) laser light source was used for measurements.

### <Transmittance of Cured Product>

The transmittance of the cured product indicates the transmittance of light with a wavelength of 580 nm at a thickness of 10 μm.

In addition, the appearance and strength of each cured product was evaluated in accordance with the criteria shown below.

“Appearance”: The presence or absence of cracking (cracks) in the cured product was evaluated visually.

“Strength”: The presence or absence of tack was evaluated by touching the surface of the cured product with a finger.

TABLE 1

| | | | Practical examples/comparative examples | | |
|---|---|---|---|---|---|
| | | | Practical | Practical | Practical |
| | | | Example 1 | Example 2 | Example 3 |
| Composition | (ViMe₂SiO_{1/2})₂₅(PhSiO_{3/2})₇₅ | | — | — | — |
| % by mass | (ViPhMeSiO_{1/2})₄₀(NpSiO_{3/2})₆₀ | | 28.5 | 22.5 | 15 |
| (calculated solid | ViMe₂SiO(PhMeSiO)₂₀SiMe₂Vi | | — | — | 11 |
| content excluding | HMe₂SiO(Ph₂SiO)SiMe₂H | | 11.5 | — | — |
| toluene) | HMe₂SiO(Ph₂SiO)_{2.5}SiMe₂H | | — | 17.5 | 14 |
| | MeSiPh₂OH | | 5 | 5 | 5 |
| | Surface treatment agent No. 1 | | 5 | 5 | 5 |
| | Barium titanate | | 50 | 50 | 50 |
| SiH/Vi ratio | | | 1.0 | 1.0 | 1.0 |
| Characteristics of | Refractive index (633 nm) | | 1.719 | 1.687 | 1.642 |
| the cured product | Appearance/strength | Cracks | No | No | No |
| | | Tack | No | No | No |

| | | | Practical examples/comparative examples | | | |
|---|---|---|---|---|---|---|
| | | | Comparative | Practical | Practical | Comparative |
| | | | Example 1 | Example 4 | Example 5 | Example 2 |
| Composition | (ViMe₂SiO_{1/2})₂₅(PhSiO_{3/2})₇₅ | | 15 | — | — | 20 |
| % by mass | (ViPhMeSiO_{1/2})₄₀(NpSiO_{3/2})₆₀ | | — | 20 | 37 | — |
| (calculated solid | ViMe₂SiO(PhMeSiO)₂₀SiMe₂Vi | | 12 | 14 | — | 15.5 |
| content excluding | HMe₂SiO(Ph₂SiO)SiMe₂H | | — | — | — | — |
| toluene) | HMe₂SiO(Ph₂SiO)_{2.5}SiMe₂H | | 13 | 18 | 27 | 16.5 |
| | MeSiPh₂OH | | 5 | 4 | 3 | 4 |
| | Surface treatment agent No. 1 | | 5 | 4 | 3 | 4 |
| | Barium titanate | | 50 | 40 | 30 | 40 |
| SiH/Vi ratio | | | 1.0 | 1.0 | 1.0 | 1.0 |
| Characteristics of | Refractive index (633 nm) | | 1.599 | 1.617 | 1.650 | 1.586 |
| the cured product | Appearance/strength | Cracks | No | No | No | No |
| | | Tack | No | No | No | No |

### Example 6, Comparative Example 3

### Evaluation of the Curable Organopolysiloxane Composition and the Cured Product

With the compositions illustrated in Table 2, the titanium oxide dispersion 2 described above in an amount so that the titanium oxide content was a prescribed amount, a vinyl functional polyorganosiloxane, and an SiH functional polyorganosiloxane were mixed. Next, a platinum complex of 1,3-divinyltetramethyldisiloxane was mixed in an amount so that the platinum metal was 2 ppm in weight units with respect to the solid content so as to prepare a solution of a curable organopolysiloxane composition.

This solution of the curable organopolysiloxane was dripped onto a glass plate and dried for one hour at 70° C. After the solvent was removed, the mixture was heated for 2 hours at 150° C. to obtain a cured product.

The makeup of the cured organopolysiloxane compositions and the evaluation results of the cured products are shown in Table 1. The SiH/Vi ratio in the table represents the number of moles of silicon-bonded hydrogen atoms in the SiH functional polyorganosiloxane with respect to a total of 1 mole of the dispersion and vinyl groups in the vinyl functional polyorganosiloxane in the curable organopolysiloxane composition.

The evaluation criteria for each characteristic are the same as in Examples 1 to 5.

TABLE 2

| | | | | Com- |
|---|---|---|---|---|
| Practical example/ | | | Practical | parative |
| comparative example | | | Example 6 | Example 3 |
| Composition | (ViMe₂SiO_{1/2})₂₅(PhSiO_{3/2})₇₅ | | — | 33.7 |
| % by mass | (ViPhMeSiO_{1/2})₄₀(NpSiO_{3/2})₆₀ | | 31.2 | — |
| (calculated | HMe₂SiO(Ph₂SiO)SiMe₂H | | 25.5 | 23 |
| solid content | Surface treatment agent No. 1 | | 10 | 10 |
| excluding | Titanium oxide | | 33.3 | 33.3 |
| toluene) | | | | |
| SiH/Vi ratio | | | 1.0 | 1.0 |
| Characteristics | Refractive index (633 nm) | | 1.688 | 1.680 |
| of the cured | Appearance/ | Cracks | No | No |
| product | strength | Tack | No | No |

As illustrated in each example, the curable organopolysiloxane composition of the present invention demonstrated a higher refractive index when an equivalent amount of metal oxide microparticles were added, and no cracks or adverse effects were observed in the physical properties required for optical material applications.

1. A curable silicone composition comprising:
(A) an organopolysiloxane represented by the average unit formula:
(R¹₃SiO_{1/2})ₐ(R¹₂SiO_{2/2})_{b}(R²SiO_{3/2})_{c}(SiO_{4/2})d
wherein, the R¹ moieties are alkyl groups, alkenyl groups, phenyl groups, or hydrogen atoms; the R² moieties are groups represented by R¹, condensed polycyclic aromatic groups, or groups including a condensed polycyclic aromatic group, provided that at least one of the R¹ and R² moieties in the molecule is an alkenyl group or hydrogen atom and at least one R² moiety in the molecule is a condensed polycyclic aromatic group or a group including a condensed polycyclic aromatic group; and a, b, c, and d are numbers satisfying the formulae:
0.01≦a≦0.8, 0≦b≦0.5, 0.2≦c≦0.9, 0≦d<0.2, and a+b+c+d=1;
and
(B) metal oxide microparticles with a cumulant average particle size of not greater than 500 nm and a refractive index of not less than 1.55 for light of a wavelength of 633 nm at 25° C.

2. The curable silicone composition according to claim 1, wherein the component (A) is an organopolysiloxane in which at least 50 mol % of the R² moieties in the formula are condensed polycyclic aromatic groups or groups containing condensed polycyclic aromatic groups.

3. The curable silicone composition according to claim 1, wherein the component (A) is an organopolysiloxane in which at least 50 mol % of the R² moieties in the formula are naphthyl groups.

4. The curable silicone composition according to claim 1, further comprising: (C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1), where n is a number equal to 1 or greater; and
having at least one structure in the molecule in which the silicon atoms are bonded to any siloxane unit represented by R³¹3 SiO_{1/2}, R³¹2 SiO_{2/2}, R³¹SiO_{3/2}, and SiO_{4/2}, wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1).

5. The curable silicone composition according to claim 4, wherein the component (B) comprises metal oxide microparticles that have been surface-treated by the component (C).

6. The curable silicone composition according to claim 1, wherein the refractive index after curing is at least 1.55.

7. The curable silicone composition according to claim 1 comprising: (A1) an organopolysiloxane represented by the average unit formula:
(R¹¹₃SiO_{1/2})ₐ(R¹¹₂SiO_{2/2})_{b}(R²¹SiO_{3/2})_{c}(SiO_{4/2})_{d}
wherein the R¹¹ moieties are alkyl groups, alkenyl groups, or phenyl groups; the R²¹ moieties are groups represented by R¹¹, condensed polycyclic aromatic groups, or groups including a condensed polycyclic aromatic group, provided that at least one of the R¹¹ and R²¹ moieties in the molecule is an alkenyl group and at least 50 mol % of the R²¹ moieties in the molecule are naphthyl groups; and a, b, c, and d are numbers satisfying the formulae:
0.01≦a≦0.8, 0≦b≦0.5, 0.2≦c≦0.9, 0≦d<0.2, and a+b+c+d=1;
(B) metal oxide microparticles with a cumulant average particle size of not greater than 200 nm and a refractive index of not less than 1.55;
(C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1), where n is a number equal to 1 or greater and
having at least one structure in the molecule in which the silicon atoms are bonded to any siloxane unit represented by R³¹₃SiO_{1/2}, R³¹₂SiO 2/2, R³¹SiO_{3/2}, and SiO_{4/2}, wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1);
(D1) an organopolysiloxane having at least two silicon-bonded hydrogen atoms in each molecule; and
(E) a hydrosilylation reaction catalyst.

8. The curable silicone composition according to claim 1 comprising: (A2) an organopolysiloxane represented by the average unit formula:
(R¹²₃SiO_{1/2})ₐ(R¹²₂SiO_{2/2})_{b}(R²²SiO_{3/2})_{c}(SiO_{4/2})_{d}
wherein the R¹² moieties are alkyl groups, phenyl groups, or hydrogen atoms; the R²² moieties are groups represented by R¹², condensed polycyclic aromatic groups, or groups including a condensed polycyclic aromatic group, provided that at least one of the R¹² and R²² moieties in the molecule is a hydrogen atom and at least 50 mol % of the R²² moieties in the molecule are naphthyl groups; and a, b, c, and d are numbers satisfying the formulae:
0.01≦a≦0.8, 0≦b≦0.5, 0.2≦c≦0.9, 0≦d<0.2, and a+b+c+d=1;
(B) metal oxide microparticles with a cumulant average particle size of not greater than 200 nm and a refractive index of not less than 1.55;
(C) an organic silicon compound having at least one structure in the molecule comprising a functional group selected from a highly polar functional group, a hydroxyl group-containing group, a silicon atom-containing hydrolyzable group, or metal salt derivatives thereof bonded to silicon atoms directly or via a functional group with a valency of (n+1), where n is a number equal to 1 or greater; and
having at least one structure in the molecule in which the silicon atoms are bonded to any siloxane unit represented by R³¹₃SiO_{1/2}, R³¹₂SiO_{2/2}, R³¹SiO_{3/2}, and SiO_{4/2}, wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1);
(D2) an organopolysiloxane having at least two alkenyl groups in each molecule; and
(E) a hydrosilylation reaction catalyst.

9. The curable silicone composition according to claim 4, wherein the component (C) is an organic silicon compound having: an alkenyl group or a silicon-bonded hydrogen atom in the molecule; and
a silicon-bonded hydrolyzable group or hydroxyl group bonded to silicon atoms directly or via a functional group with a valency of (n+1), where n is a number equal to 1 or greater.

10. The curable silicone composition according to claim 1, further comprising (F) a fluorescent material.

11. A cured product produced by curing the curable silicone composition according to claim 1.

12. A semiconductor sealing material comprising the curable silicone composition according to claim 1.

13. An optical semiconductor device formed by covering or sealing an optical semiconductor element with the curable silicone composition according to claim 1.

14. The curable silicone composition according to claim 2, further comprising:
(C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1), where n is a number equal to 1 or greater; and
having at least one structure in the molecule in which the silicon atoms are bonded to any siloxane unit represented by R³¹₃SiO_{1/2}, R³¹₂SiO_{2/2}, R³¹SiO_{3/2}, and SiO_{4/2}, wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1).

15. The curable silicone composition according to claim 3, further comprising:
(C) an organic silicon compound having a functional group selected from a highly polar functional group, a hydroxyl group-containing group, a silicon atom-containing hydrolyzable group, or metal salt derivatives thereof bonded to silicon atoms directly or via a functional group with a valency of (n+1), where n is a number equal to 1 or greater; and
having at least one structure in the molecule in which the silicon atoms are bonded to any siloxane unit represented by R³¹₃SiO_{1/2}, R³¹₂SiO_{2/2}, R³¹SiO_{3/2}, and SiO_{4/2}, wherein R³¹ is a substituted or unsubstituted monovalent hydrocarbon group, a hydrogen atom, a halogen atom, a hydroxyl group, an alkoxy group, or a functional group selected from a highly polar functional group, a hydroxyl group-containing group, a silicon atom-containing hydrolyzable group, or metal salt derivatives thereof bonded to silicon atoms via a functional group with a valency of (n+1).
